(19) United States
(12) Patent Application Publication
(10) Pub. No.: US 2019/0068981 A1
(43) Pub. Date: Feb. 28, 2019

(54) STORING AND RETRIEVING LOSSY-COMPRESSED HIGH BIT DEPTH IMAGE DATA

(71) Applicant: QUALCOMM Incorporated, San Diego, CA (US)

(72) Inventors: In Suk Chong, San Diego, CA (US); Cheng-Teh Hsieh, Del Mar, CA (US); Xianglin Wang, San Diego, CA (US)

(21) Appl. No.: 15/684,711

(22) Filed: Aug. 23, 2017

(51) Int. Cl. H04N 19/184; H04N 19/176; H04N 19/52; H04N 19/11; H04N 19/70; H04N 19/593; H04N 19/91

(52) U.S. Cl. CPC H04N 19/184; H04N 19/176; H04N 19/52; H04N 19/91; H04N 19/70; H04N 19/593; H04N 19/11

(57) ABSTRACT

An example device for accessing image data includes a memory configured to store image data, the memory comprising a first region and a second region, and one or more processing units implemented in circuitry and configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, determine whether to represent the residuals using both the MSBs and least significant bits (LSBs) of the plurality of residuals of the samples, and in response to determining not to represent the residuals using the LSBs, prevent access of the LSBs in a second region of the memory.

### TECHNICAL FIELD

This disclosure relates to storage and retrieval of image data.

### BACKGROUND

Image data is used in a variety of applications, such as pictures and videos. Raw image data (that is, uncoded or decoded image data, such as pictures, video, graphics, or display data) is often stored prior to encoding, following decoding, following rendering, and/or in a display buffer for image data to be displayed. Storage and retrieval of raw image data tends to suffer bandwidth limitations in core processing systems, such as video, image, graphics, and display core systems.

Image processing systems such as video, image, and graphics processing pipelines, include various intermediate modules that access raw data (e.g., fetched or stored) as needed for processing. For example, in the case of video processing, intermediate modules fetch raw data in the form of reference pixel data, original pixel data, reconstructed pixel data, and the like. Such data access requires high bandwidth (BW) usage, which leads to high power consumption. This is especially true for higher bit-depth (i.e., more than 8 bits/sample) data used in those pipelines (e.g., 10- or 12-bit high dynamic range (HDR) video processing). In such cases, the situation will be even worse with the burden of memory access (both internal and external memory) significantly increased due to data size misalignment. Usually, padding is needed for such higher bit-depth data to make the bits of the samples aligned with the normal word or byte memory accessing boundaries.

For example, 10-bit pixels may be stored in a 16-bit memory unit (such as in a P010 format), with 6 bits used only for padding purposes and not contributing to the actual sample value. Direct access of such data incurs a 37.5% bandwidth waste.

As another example, three 10-bit pixels could be stored into a 32-bit memory unit, with 2 bits unused for padding purpose. Direct access of such data incurs at least 6.25% bandwidth waste.

### SUMMARY

In general, this disclosure describes techniques for accessing (e.g., storing and retrieving) image data, particularly high bit depth image data. The techniques of this disclosure generally include compressing most significant bits (MSBs) of samples in a block of an image, while leaving least significant bits (LSBs) of the samples uncompressed. In particular, the LSBs may be selectively stored and/or retrieved, or omitted from storage or retrieval, based on whether part or all of an image processing pipeline can handle lossy compression of pixels of the image data. In addition, header data for each block may signal whether the MSBs are coded, and if so, the number of MSBs coded for each sample of the block. When the MSBs are coded (that is, compressed), the compression may be performed in a lossless manner. The MSBs (and when stored, the LSBs) may be stored together or separately, depending on the context in which these techniques are applied.

In one example, a method of accessing image data includes coding most significant bits (MSBs) of a plurality of residuals of samples of a block of an image, each of the residuals representing a respective difference value between a respective raw sample value and a respective predicted value for the respective raw sample value, accessing the coded MSBs in a first region of a memory, determining whether to represent the residuals using both the MSBs and least significant bits (LSBs) of the plurality of residuals of the samples, and in response to determining not to represent the residuals using the LSBs, preventing access of the LSBs in a second region of the memory.

In another example, a device for accessing image data includes a memory configured to store image data, the memory comprising a first region and a second region, and one or more processing units implemented in circuitry and configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, determine whether to represent the residuals using both the MSBs and least significant bits (LSBs) of the plurality of residuals of the samples, and in response to determining not to represent the residuals using the LSBs, prevent access of the LSBs in a second region of the memory.

In another example, a device for accessing image data includes means for coding most significant bits (MSBs) of a plurality of residuals of samples of a block of an image, each of the residuals representing a respective difference value between a respective raw sample value and a respective predicted value for the respective raw sample value, means for accessing the coded MSBs in a first region of a memory, means for determining whether to represent the residuals using both the MSBs and least significant bits (LSBs) of the plurality of residuals of the samples, and means for preventing, in response to determining not to represent the residuals using the LSBs, access of the LSBs in a second region of the memory.

In another example, a computer-readable storage medium has stored thereon instructions that, when executed, cause a processor to code most significant bits (MSBs) of a plurality of residuals of samples of a block of an image, each of the residuals representing a respective difference value between a respective raw sample value and a respective predicted value for the respective raw sample value, access the coded MSBs in a first region of a memory, determine whether to represent the residuals using both the MSBs and least significant bits (LSBs) of the plurality of residuals of the samples, and in response to determining not to represent the residuals using the LSBs, prevent access of the LSBs in a second region of the memory.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for accessing image data.

FIG. 2 is a block diagram illustrating an example lossy AMSBC system configured to perform the techniques of this disclosure.

FIG. 3 is a block diagram illustrating an example packet including data for a block of an image in accordance with the techniques of this disclosure.

FIG. 4 is a conceptual diagram illustrating block of residual values.

FIG. 5 is a block diagram illustrating an example camera device that may use the techniques of this disclosure.

FIG. 6 is a block diagram illustrating an example video encoder including a picture processing unit that implements techniques for accessing high bit depth image data in accordance with the techniques of this disclosure.

FIG. 7 is a block diagram illustrating an example of a graphics processing unit (GPU) including a picture processing unit that implements techniques for accessing high bit depth image data in accordance with the techniques of this disclosure.

FIG. 8 is a conceptual diagram illustrating an example method of coding a block of image data in accordance with the techniques of this disclosure.

FIG. 9 is a conceptual diagram illustrating an example method for encoding a block of image data in accordance with the techniques of this disclosure.

FIG. 10 is a conceptual diagram illustrating an example method for decoding a block of image data in accordance with the techniques of this disclosure.

### DETAILED DESCRIPTION

In general, this disclosure describes techniques for accessing (e.g., storing and/or retrieving) image data. Such techniques generally include accessing (e.g., storing and/or retrieving) image data in a memory in a bandwidth-efficient manner. In particular, when storing image data for example, a processing unit may partition the image into individual blocks of pixels. The processing unit may predict values for the pixels, e.g., using left- and/or above-neighboring pixels, and calculate residual values for the pixels representing differences between the predicted values and the actual values. The processing unit may then partition the residual values into most-significant bits (MSBs) and least-significant bits (LSBs). The processing unit may encode (e.g., in a lossless manner) the MSBs, and then store the encoded MSBs and the uncoded LSBs.

To retrieve the image data, the processing unit may perform a reciprocal process. That is, the processing unit may predict the pixels using reconstructed pixel values of left- and/or above-neighboring pixels. The processing unit may decode the MSBs values and concatenate the MSBs values with the respective LSBs values. The processing unit may then add the concatenated MSBs and LSBs values to the predicted values to reconstruct the pixel values for a block.

As explained in greater detail below, these techniques may be performed in a variety of contexts. For example, these techniques may be used to store raw image data in a still image camera, a video camera, a graphics processing pipeline, a display buffer, or in other contexts.

The processing unit may determine the number of MSBs dynamically. For example, the processing unit may determine the number of MSBs based on a total number of bits used for each residual value based on the size of a byte (i.e., eight bits), e.g., to ensure that the LSBs are byte-aligned. In some examples, the MSBs may correspond to the difference between the total number of bits for the residuals and eight bits (that is, one byte). For example, for 10-bit data, the MSBs may correspond to the two most significant bits of the residual values, and the LSBs may correspond to the remaining eight bits. In still other examples, there may be a variable number of MSBs from block to block.

The techniques of this disclosure may address one or more problems with conventional image storage techniques. For example, this disclosure recognizes that there exists a high bandwidth requirement for image data access. This high bandwidth requirement may not only limit overall system processing capabilities, but also significantly increase power consumption, and therefore degrade overall product quality, especially for mobile devices. Furthermore, data processing requirements, especially for mobile devices, continue to increase, in terms of video spatial and temporal resolutions and bit-depth resolution. Accordingly, the corresponding data bandwidth requirements continue to increase significantly. Accessing image data in memory is one of the major bottlenecks in image and video processing unit implementations on mobile devices. For multimedia data, some degree of loss can be acceptable, as long as perceptually lossless properties are maintained. Thus, the techniques of this disclosure may reduce the bandwidth requirements for accessing image and video data for image and video processing.

To reduce memory access bandwidth requirements for image or video data, this disclosure describes techniques that may be used to compress a number of most significant bit (MSB) from each pixel in a lossless manner. More specifically, given a block of video data, a number of MSB from each pixel may be separated from its LSB portion to form a block of MSB video data and a block of LSB video data respectively. Lossless compression may then be applied to the MSB block to effectively reduce the data size before it is used for memory access.

During memory access, the block of video data may be fetched in a manner such that the compressed MSB portion and the non-compressed LSB portion are fetched together. With proper decoding, the MSB portion may be reconstructed to original values and used together with the LSB portion. With the MSB portion significantly compressed, such a scheme can effectively reduce actual memory access bandwidth requirements.

Additionally, the number of MSBs from each pixel used to form the MSB block does not have to be a fixed value. Instead, the number may be adaptively determined and signaled in the compressed MSB bitstream. As a result, such techniques may be referred to as Adaptive Most Significant Bits Compression (AMSBC).

One general idea of AMSBC is based on the correlation characteristics of images and/or video data, that is, the amplitude correlation among spatially neighbored video/image samples. Especially, MSB bits among neighboring samples may be significantly more correlated than LSB bits. As a result, a high compression ratio can be achieved, even with lossless coding.

ASMBC can naturally support both lossless and lossy compression. In AMSBC, the MSB portion of pixel data is coded in a lossless manner, while the LSB portion can be wholly kept or selectively discarded from the bitstream. When the LSB portion is wholly kept, compression is lossless. If some or all of the LSB portion is selectively discarded, compression is lossy. For example, the first 1 or 2 bits of the LSB portion may be discarded to achieve a better compression ratio and save more bandwidth/power. The price paid is distortion between the reconstructed video data and the original video data. Such distortion may cause noticeable visual distortion. The techniques of this disclosure may be used to reduce and/or minimize such visual distortion, while maintaining a good compression ratio.

This disclosure describes various techniques, which may be applied individually or in any combination, that may improve visual quality for lossy compression. A first example technique is to use reconstructed pixels for prediction, to minimize error drift. A second example technique is to use an adaptive offset value to generate the MSB portion of residual values. A third example technique is to apply a clipping operation on residual values when generating the MSB portion of a residual to avoid underflow and/or overflow of reconstructed pixels. A fourth example technique is to determine a number of LSBs (num_lsb_bits) based on video characteristics, such as texture luminance level, or the like. For example, for a darker area, a lower number of LSBs may be used, whereas for a high texture area, a higher number of LSBs may be used. Applying these techniques individually or in any combination may result in visually lossless video quality, while achieving a reasonable compression ratio for efficient bandwidth and/or power reduction.

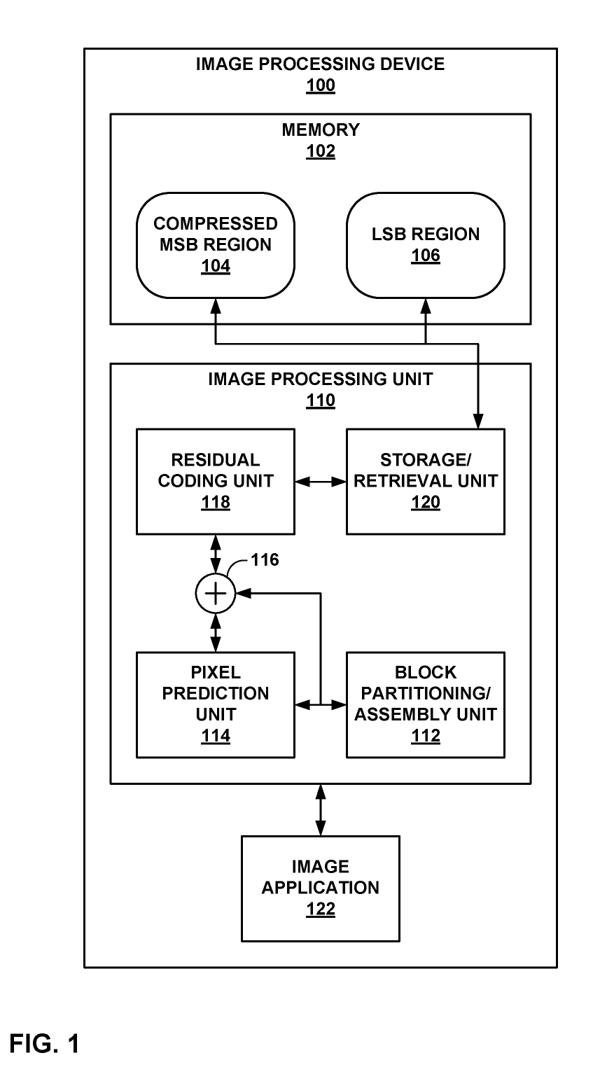

FIG. 1 is a block diagram illustrating an example image processing device 100 that may perform the techniques of this disclosure. In this example, image processing device 100 includes memory 102, image processing unit 110, and image application 122. Image application 122 represents one or more image applications that may store and/or retrieve data to/from memory 102. For example, image application 122 may represent an application that receives one or more still images from a camera (not shown) of image processing device 100. As another example, image application 122 may represent a computer graphics program, such as a video game, ray tracing program, computer graphics generation program for digital movie production, or the like. As still another example, image application 122 may represent a controller for a display buffer (not shown) that stores images until the images are ready to be displayed on a display (not shown) coupled to or incorporated into image processing device 100.

Memory 102 may represent any of a variety of computer-readable storage media for storing data. For example, memory 102 may represent a random access memory (RAM), such as dynamic random access memory (DRAM), extended data-out RAM (EDO RAM), synchronous DRAM (SDRAM), double data rate SDRAM (DDR SDRAM), or the like. Alternatively, memory 102 may represent read-only memory (ROM), such as programmable ROM (PROM), erasable programmable ROM (EPROM), electronically erasable programmable read only memory (EEPROM), or the like. As still another example, memory 102 may represent a hard disk, flash drive, solid state drive, tape drive, or the like. Furthermore, memory 102 may include any combination of these or other computer-readable storage media.

Image processing unit 110 provides access to image data stored on memory 102 by image application 122 in the example of FIG. 1. In this example, image processing unit 110 includes block partitioning/assembly unit 112, pixel prediction unit 114, addition/subtraction unit 116, residual coding unit 118, and storage/retrieval unit 120.

When storing an image to memory 102, image processing unit 110 may initially receive the image from image application 122. Image processing unit 110 passes the image to block partitioning/assembly unit 112, which partitions the image into individual blocks of pixels. The blocks may have fixed or variable sizes, which may be square, rectangular, or non-rectangular shapes. For example, the blocks may have square or rectangular shapes defined by the number of pixels included in the blocks, such as 4×4, 4×8, 8×4, 8×8, 16×4, 16×8, 16×16, 4×16, 8×16, 32×4, 32×8, 32×16, 32×32, 4×32, 8×32, 16×32, and so on. The blocks of an image may have a common size or different sizes. Block-based partitioning may take advantage of correlation of neighboring pixels in an image for better compression efficiency, and also offer the ease of random access and processing. Block shape and size may be dependent on user implementation preferences and/or requirements of image application 122.

After block partitioning/assembly unit 112 partitions an image into blocks, the remaining components of image processing unit 110 may process the blocks according to the techniques of this disclosure. For example, pixel prediction unit 114 may predict values for pixels of a block based on previously coded pixels of the block. Assuming the pixels are processed in a raster scan order, pixel prediction unit 114 may use a value of “0” as a predictor for the upper-left pixel of the block. For subsequent pixels of the block in the top row, pixel prediction unit 114 may predict the pixels using reconstructed values for left-neighboring pixels.

After predicting and coding the top row of pixels, pixel prediction unit 114 may predict the remaining pixels of the block using reconstructed values for left-, above-left, and/or above-neighboring pixels, alone or in combination. For example, pixel prediction unit 114 may derive a predictor for a current pixel by adding the reconstructed values for the left-neighboring pixel and the above-neighboring pixel, then subtracting the value for the above-left neighboring pixel. Pixel prediction unit 114 may predict pixels along the left edge of the block using reconstructed values for above-neighboring pixels. Pixel prediction unit 114 may signal values for syntax elements indicating whether pixels are predicted from left-, above-left and/or above-neighboring pixels, in some examples. Using such a prediction strategy, all predictors are within the current block, and therefore there is no dependency between blocks, which allows the techniques of this disclosure to be random access friendly.

Addition/subtraction unit 116 calculates residual values for the pixels of the block. In particular, addition/subtraction unit 116 calculates the difference between an actual value for a pixel and the predicted value for the pixel as the residual value for the pixel. In this manner, addition/subtraction unit 116 produces a block of residual values. The prediction and residual calculation processes performed by pixel prediction unit 114 and addition/subtraction unit 116 may effectively increase the correlation of most significant bits (MSBs) of neighboring residual values, thereby improving compression efficiency for compression performed by residual coding unit 118. In this manner, MSBs and least significant bits (LSBs) discussed herein refer to MSBs and LSBs of residual values, rather than the pixel values directly.

Residual coding unit 118 may then encode the residual values according to the techniques of this disclosure. During encoding of the residual values, residual coding unit 118 may determine, from the residual values a number of MSBs to be compressed. The number of MSBs is equal to the residual data bit depth (which is a constant value) minus the number of LSBs (num_lsb_bits). Thus, determining the number of LSBs and determining the number of MSBs are functionally equivalent. Residual coding unit 118 may determine the number of LSBs using one or more metrics collected during pre-processing of a block to which the residual values correspond. Such metrics may include those measuring texture richness and/or pixel luminance level.

To measure texture richness (e.g., the degree of texture) within a block, residual coding unit 118 (or image processing unit 110) may use a metric of magnitude of the residual after performing differential pulse code modulation (DPCM) on the original pixels of the block. By comparing the magnitude of the residual against several threshold values, residual coding unit 118 can determine the number of LSBs (num_lsb_bits) for each pixel of the block. In general, residual coding unit 118 may apply more compression to a block with more complex texture (i.e., with a larger magnitude of residual), and less compression to a block with simpler texture (i.e., with a smaller magnitude of residual). More compression usually leads to relatively larger distortion between reconstructed samples and original samples. However, if such distortion is associated with a complex texture area, the distortion is generally much less visible than having the same distortion in a smooth or low texture area. Determining the value of num_lsb_bits adaptively as described above may lead to overall better visual quality.

One example algorithm (1) for applying different threshold values to decide num_lsb_bits is as follows:

if (residual_magnitude < lsb_bit_Th_2)

then num_lsb_bits = 0

else if (residual_magnitude < lsb_bit_Th_1)

then num_lsb_bits = 1

else

num_lsb_bits = 2

if (residual_magnitude > lsb_bit_Th_3)

| | |
|---|---|
| then num_lsb_bits = 3 | (1) |

In the example algorithm (1) above, residual coding unit 118 may determine the threshold values lsb_bit_Th_1, lsb_bit_Th_2, and lsb_bit_Th_3 based on luminance level of the current block. Residual coding unit 118 may determine the luminance level from average pixel values within the block. Different sets of threshold values may lead to different levels of compression. For example, for a block having a low luminance level (i.e., with a low pixel average value), residual coding unit 118 may use fewer LSBs by setting the threshold values above to higher values, whereas for a block having a higher luminance level (i.e., with a high pixel average value), residual coding unit 118 may use more LSBs by setting the threshold values above to lower values.

Another example algorithm (1.5) for applying different threshold values to decide num_lsb_bits is as follows:

determine initial number of LSBs value init_LSB
if (residual_magnitude < lsb_bit_Th_2)

then num_lsb_bits = init_LSB

else if (residual_magnitude < lsb_bit_Th_1)

then num_lsb_bits = init_LSB + 1

else

num_lsb_bits = init_LSB + 2

if (residual_magnitude > lsb_bit_Th_3)

| | |
|---|---|
| then num_lsb_bits = init_LSB + 3 | (1.5) |

In the example of algorithm (1.5), init_LSB represents an initial number of LSBs value, which may be defined in configuration data. Using the various thresholds as discussed with respect to algorithm (1) above, the algorithm includes modifying the init_LSB value by, e.g., adding one, two, or three, or leaving the init_LSB value intact.

After determining the number of MSBs and LSBs, to determine MSBs and LSBs of the residual values for encoding, residual coding unit 118 may perform the following algorithm (2) for each residual value:

if (num_lsb_bit > 1)

offset = 1 << (num_lsb_bit − 1)

else

offset = 0

residual_MSB_t = residual_sign * ( (|residual| + offset) >>
num_lsb_bit)
max_val = (1<<bitdepth) − 1
residual_MSB = CLIP3(−(predictor >> num_lsb_bit), (max_val −

predictor) >> num_lsb_bit, residual_MSB_t)

| | |
|---|---|
| residual_LSB = residual − (residual_MSB << num_lsb_bit) | (2) |

In the example algorithm (2) above, ‘<<’ and ‘>>’ represent the bitwise left-shift and right-shift operators, respectively, residual_sign represents the sign (positive or negative) of the residual value for the current residual value, ‘|residual|’ represents the absolute value of the current residual value, residual_MSB represents the value of the MSBs, and residual_LSB represents the value of the LSBs. Residual_MSB_t represents a temporary value during the calculation. CLIP3(a, b, x) represents a clipping operation that clips the value of x (residual_MSB_t, in this example) to be within the range of (a, b), or between −(predictor>>num_lsb_bit) and (max_val−predictor), in this example. This is, CLIP3(a, b, x) may be implemented according to the algorithm:

CLIP3(a,b,x)=Max(a,Min(b,x)).

In the example algorithm (2) above, residual coding unit 118 may initially determine an offset value based on the number of LSBs. In this example algorithm, residual coding unit 118 sets the value of offset to 0 if num_lsb_bit is equal to or less than 1, otherwise, residual coding unit 118 sets the value of offset equal to one left-shifted by num_lsb_bit minus 1. Residual coding unit 118 then calculates a temporary value, residual_MSB_t, as being equal to the residual_sign multiplied by the absolute value of the residual value plus the offset right-shifted by num_lsb_bit. Residual coding unit 118 also calculates a variable value max_val as being equal to one left-shifted by bitdepth of the block, minus 1. Residual coding unit 118 then calculates the residual_MSB value as being equal to residual_MSB_t, clipped to within the range of the negative value of predictor right-shifted by num_lsb_bit and max_val minus the value of the predictor. Residual coding unit 118 also calculates the value of residual_LSB as being equal to the residual value minus residual_MSB left-shifted by num_lsb_bit.

As a modification to the example of algorithm (2) above, “offset=1<<(num_lsb_bit−1)” may be replaced with “set offset according to image characteristic,” where the image characteristic may be a value representative of the image, e.g., variance of the image. For example, if variance is large, a smaller offset of alpha*offset(alpha<1.0) may be used.

In various examples, residual coding unit 118 may encode only the MSBs or both the MSBs and LSBs. Alternatively, at decoding time, storage/retrieval unit 120 may retrieve only the encoded MSBs from compressed MSB region 104 or both the MSBs from compressed MSB region 104 and the LSBs from LSB region 106. In some examples, if lossy data is good enough for all stages of a corresponding pipeline, residual coding unit 118 and/or storage/retrieval unit 120 may discard the LSB part of the data. If some pipeline stages require only lossy data and other pipeline stages require lossless data, storage/retrieval unit 120 may initially retrieve the MSBs from compressed MSB region 104, then later retrieve and send the LSBs from LSB region 106. Additionally, residual coding unit 118 may use the LSBs to achieve lossless reconstruction, per the following algorithm (3):

Lossy_reconst = predictor_lossy + (residual_MSB << num_lsb_bit),

where predictor_lossy is using reconstructed values for
neighboring pixels (i.e., left/above/above-left neighboring pixels)

| | |
|---|---|
| Lossless_reconst = lossy_reconst + residual_LSB | (3) |

In one example, residual coding unit 118 may perform run length coding using variable length coding (VLC) to compress the MSBs of the residual values of a block. In run-length coding using VLC, residual coding unit 118 determines the value of the MSBs of a current residual value, as well as the number of residual values having MSBs of the same value in coding order (e.g., raster scan order). Residual coding unit 118 then selects a VLC codeword representing both the MSBs value and the run value. Residual coding unit 118 may continue selecting such codewords until the block has been fully coded. Run length coding using VLC represents an example of lossless coding. That is, by using the VLC codewords, the MSBs of the residual values of the block can be reconstructed without loss.

Residual coding unit 118 may use fixed VLC codeword tables or dynamic/adaptive VLC codeword tables. Examples of techniques for generating fixed VLC codeword tables include Truncated-Unary (TU) codeword table generation and Exponential-Golomb (EG) codeword table generation. Alternatively, residual coding unit 118 may generate or update a VLC codeword table on the fly, for example, based on the number of MSBs to be compressed.

After coding the MSBs in this fashion, residual coding unit 118 may determine whether the number of bits used to represent the coded MSBs combined with the number of bits in the LSBs is smaller than the total number of bits used to represent the original pixel values for the block, representing whether the MSBs are in fact compressed. If the coded MSBs are compressed (i.e., the number of bits used to represent the coded MSBs and the LSBs is less than the number of bits used to represent the original pixel values for the block), residual coding unit 118 may signal a value for a syntax element (such as a compression flag, e.g., a one-bit flag) indicating that the MSBs are coded. Alternatively, if the coded MSBs are not sufficiently compressed (e.g., are represented using a number of bits that is greater than a threshold value less than the uncoded MSBs), residual coding unit 118 may signal a value for the syntax element (such as the compression flag) indicating that the MSBs are not coded, in which case residual coding unit 118 may code the block using pulse code modulation (PCM) mode.

In addition, residual coding unit 118 may determine the number of MSBs to be coded per residual value. For example, residual coding unit 118 may select the number of MSBs based on the lengths of the residual values for the block. In some examples, residual coding unit 118 may select the number of MSBs as a largest number of bits of the residual values that exceeds a byte boundary, such that the LSBs are byte-aligned.

Ultimately, residual coding unit 118 may produce a data structure including a syntax element indicating whether the MSBs are coded, the number of MSBs that are coded, coded data for the MSBs, and potentially uncoded data for the LSBs. In some examples, the LSBs are not stored at all following encoding, whereas in other examples, the LSBs are encoded and stored, but not ultimately retrieved. In some examples, the data structure may include pointers to memory addresses of the LSBs, if the LSBs are stored separately from the data structure. In still other examples, the data structure may include a pointer to a memory address including a set of one or more pointers to the memory addresses of the LSBs, if the LSBs are stored in memory 102. Residual coding unit 118 provides this data structure, along with the LSBs, to storage/retrieval unit 120. Storage/retrieval unit 120 stores the data structure to compressed MSB region 104 of memory 102, and the LSBs to LSB region 106. In this manner, storage/retrieval unit 120 may store MSBs data and LSBs data to distinct regions of memory 102.

In other examples, storage/retrieval unit 120 stores MSBs data (which is compressed) and LSBs data to the same region of memory 102. That is, compressed MSB region 104 and LSB region 106 may comprise the same region. Generally, MSBs data and LSBs data could be stored separately if it is expected that individual blocks of the image will be retrieved individually, without necessarily retrieving the entire image, e.g., as may be the case for image or video coding. Such a storage scheme may be used in examples where the entire image is accessed at the same time as well, or MSBs data and LSBs data may be stored in the same region of memory 102 when the entire image is accessed at the same time. The entire image may be accessed, for example, during graphics processing or when image processing unit 110 forms part of or interacts with a display buffer.

After an image has been stored in this manner, image application 122 may request to retrieve the image. In essence, image processing unit 110 performs a reciprocal process to the process discussed above to retrieve the image. That is, storage/retrieval unit 120 retrieves the MSBs data and the LSBs data from compressed MSB region 104 and LSB region 106, respectively. In one example, storage/retrieval unit 120 may retrieve the MSBs data from compressed MSB region 104 and determine addresses of the LSBs data using pointers stored with the MSBs data, which may correspond to addresses of the LSBs data. Alternatively, the pointers to the LSBs may be stored elsewhere, e.g., with header data for the block to which the MSBs and the LSBs correspond. Storage/retrieval unit 120 then passes the MSBs data and LSBs data to residual coding unit 118.

Residual coding unit 118 reconstructs the residual values for each block by determining, for example, the VLC codewords and the corresponding MSBs values and run lengths from a VLC table. Residual coding unit 118 then concatenates each MSBs value with a corresponding LSBs value to reconstruct the residual values. Residual coding unit 118 passes a first residual value of the block, along with a predicted value of “0,” to addition/subtraction unit 116, which passes the reconstructed value to pixel prediction unit 114. Afterwards, residual coding unit 118 passes each residual value for each subsequent pixel to addition/subtraction unit 116, and pixel prediction unit 114 passes a predicted value for each pixel to addition/subtraction unit 116, which reconstructs the corresponding pixel and passes the reconstructed pixels to pixel prediction unit 114.

Ultimately, pixel prediction unit 114 receives the pixel values for each block in this manner. Pixel prediction unit 114 passes the blocks to block partitioning/assembly unit 112 to reconstruct the image (e.g., a bitstream) from the blocks. Block partitioning/assembly unit 112 may then return the reconstructed image to image application 122.

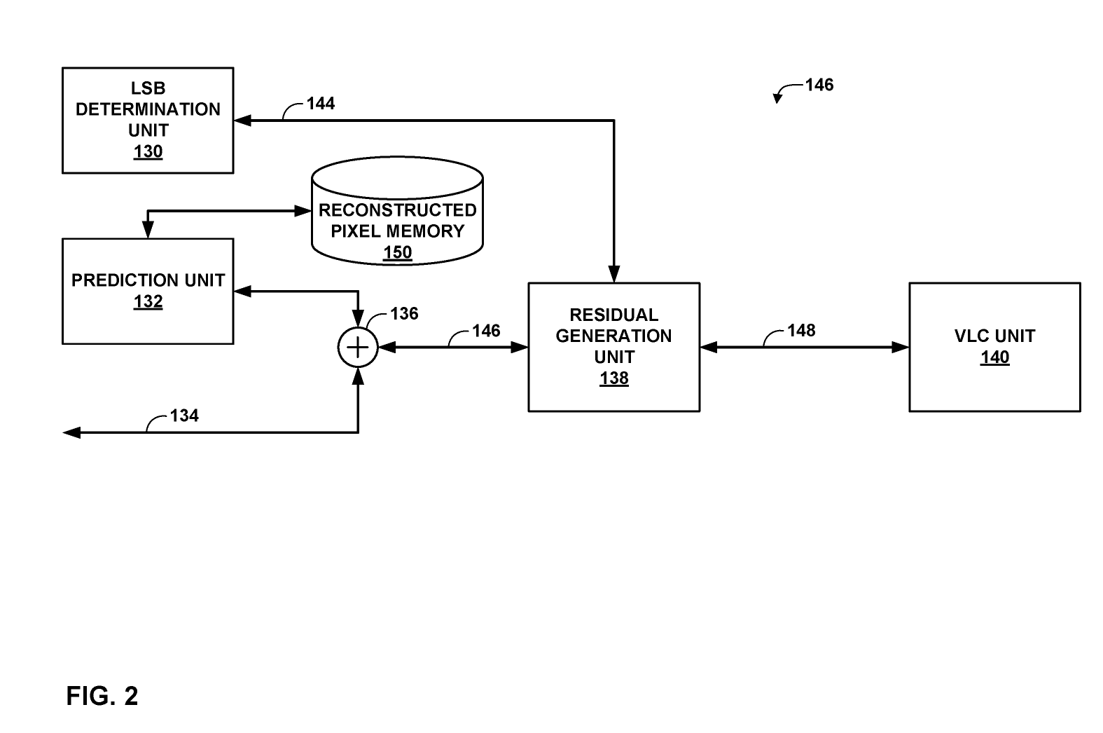

FIG. 2 is a block diagram illustrating an example lossy AMSBC system 146 configured to perform the techniques of this disclosure. In this example, lossy AMSBC system 146 includes LSB determination unit 130, prediction unit 132, addition/subtraction unit 136, residual generation unit 138, VLC unit 140, and reconstructed pixel memory 150. Lossy AMSBC system 146 may generally correspond to portions of image processing unit 110. For example, prediction unit 132 may correspond to pixel prediction unit 114, addition/subtraction unit 136 may correspond to addition/subtraction unit 116, and LSB determination unit 130, residual generation unit 138, and VLC unit 140 may correspond to residual coding unit 118.

When encoding pixels of a block, LSB determination unit 130 initially determines a number of LSBs (num_lsb_bits), e.g., using any or all of the techniques discussed above. For example, LSB determination unit 130 may determine a texture value for the block, luminance level for the block, or the like. LSB determination unit 130 may determine the number of LSBs according to algorithm (1) as discussed above.

After determining the number of LSBs, LSB determination unit 130 sends data 144 representing the number of LSBs (num_lsb_bits, for example) to residual generation unit 138. Lossy AMSBC system 146 then receives, for each pixel of the block, a current pixel 134 of the block. Prediction unit 132 generates a predicted value for the pixel, e.g., “0” if current pixel 134 is the first encoded pixel of the block, or from a reconstructed value for a neighboring (above, left, or above-left) pixel to current pixel 134. To predict pixel values from reconstructed values of neighboring pixels, residual generation unit 138 sends reconstructed (i.e., decoded) pixel values of neighboring pixels to prediction unit 132 after generating MSBs and LSBs for the pixels. Prediction unit 132 stores the reconstructed pixel values in reconstructed pixel memory 150, and retrieves the pixel values when needed for prediction from reconstructed pixel memory 150. In accordance with the techniques of this disclosure prediction unit 132 predicts the pixel using the MSBs for each of the pixels, and excluding the LSBs. As noted above, although the prediction uses the MSBs and excludes the LSBs, pixels can be decoded losslessly, e.g., according to algorithm (3) above, assuming the LSBs are stored (e.g., in LSB region 106 of memory 102 of FIG. 1).

Addition/subtraction unit 136 calculates a residual value 146 as the difference between the value of current pixel 134 and the predicted value for current pixel 134 from prediction unit 132. Addition/subtraction unit 136 then passes residual value 146 to residual generation unit 138. Residual generation unit 138 generates MSBs and LSBs for residual value 146 according to the techniques of this disclosure, e.g., according to algorithm (2) above. Residual generation unit 138 then passes residual MSBs 148 to VLC unit 140. VLC unit 140 encodes the residual MSBs 148, e.g., using run-length coding as discussed above. Lossy AMSBC system 146 may then store the MSBs (and in some examples, the LSBs), e.g., to memory 102 of FIG. 1.

Lossy AMSBC system 146 may also decode pixels of a block by performing a process reciprocal to that discussed above. In particular, lossy AMSBC system 146 may initially retrieve MSBs of residual values for pixels of a block of an image from memory. Assuming the pixels are to be decoded in a lossy mode (i.e., without using LSBs), lossy AMSBC system 146 prevents access of the LSBs in the memory (that is, lossy AMSBC system 146 does not retrieve the LSBs). By retrieving the residual MSBs, lossy AMSBC system 146 may also retrieve data defining a number of LSBs in the residuals, which lossy AMSBC system 146 may use to reconstruct the residual values at the original full bit depth (albeit without the LSBs).

In particular, the retrieved MSBs data may be run-length VLC-encoded values. Thus, VLC unit 140 may VLC-decode the run-length values to reconstruct residual MSBs for pixels of the block. Header data for the VLC-encoded run-length values may define the number of LSBs, which VLC unit 140 may provide to LSB determination unit 130 and/or residual generation unit 138. VLC unit 140 may pass the decoded residual MSBs to residual generation unit 138. Residual generation unit 138 may left-shift the residual MSBs by the number of LSBs to reconstruct the residual values (including loss introduced by not using the LSBs).

Residual generation unit 138 may then send the residual values to addition/subtraction unit 136. Prediction unit 132 may predict values for the pixels as discussed above, e.g., from left-, above-, or above-left-neighboring pixels, retrieved from reconstructed pixel memory 150. Prediction unit 132 provides the predicted values for a current pixel to addition/subtraction unit 136. Addition/subtraction unit 136 combines the predicted value for the current pixel with the residual value for the current pixel received from residual generation unit 138, and outputs a reconstructed (i.e., decoded) pixel value. Addition/subtraction unit 136 may also provide the reconstructed pixel value to prediction unit 132, to use when predicting values for subsequent pixels of the block. Prediction unit 132 stores the reconstructed pixel value to reconstructed pixel memory 150.

In this manner, image processing device 100 of FIG. 1 and lossy AMSBC system 146 of FIG. 2 represent examples of a device for accessing image data including a memory configured to store image data, the memory comprising a first region and a second region, and one or more processing units implemented in circuitry and configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, determine whether to represent the residuals using both the MSBs and least significant bits (LSBs) of the plurality of residuals of the samples, and in response to determining not to represent the residuals using the LSBs, prevent access of the LSBs in a second region of the memory.

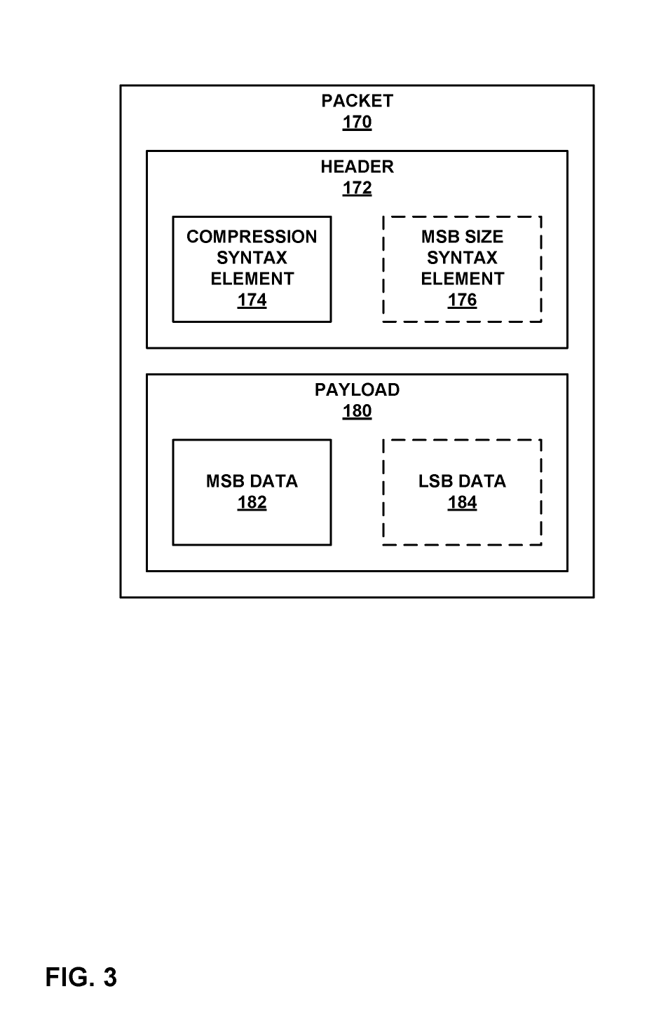

FIG. 3 is a block diagram illustrating an example packet 170 including data for a block of an image in accordance with the techniques of this disclosure. In this example, packet 170 includes header 172 and payload 180. Header 172 represents metadata and in this example includes compression syntax element 174 and MSB size syntax element 176. MSB size syntax element 176 is illustrated using a broken line to indicate that MSB size syntax element 176 is optionally present. In particular, the value of compression syntax element 174 may represent whether or not MSBs of residual values for a block corresponding to packet 170 are coded (that is, compressed).

If the value of compression syntax element 174 indicates that the MSBs are coded/compressed, MSB size syntax element 176 may be present and have a value indicating the number of MSBs included for each residual value. In other examples, rather than an MSB size syntax element 176, header 172 may include an LSB size syntax element, representing the number of LSBs (that is, the length of the LSBs). In the example of FIG. 3, the value of compression syntax element 174 may indicate that the MSBs are coded, and the value of MSB size syntax element 176 may indicate that the size of the MSBs is two (because each of residual MSBs 158 has two bits in the example of FIG. 3).

In practice, to achieve a high coding efficiency, the number of MSBs to be compressed may be dependent on data contents. For example, for smoother content where the correlation between neighboring pixels is higher, the optimal number of MSBs per pixel to compress may be larger. Therefore, according to the techniques of this disclosure, residual coding unit 118 may determine how many MSBs per residual are to be compressed adaptively during the encoding stage and signaled using MSB size syntax element 176. Such signaling may be done for each block. That is, each block of video data may correspond to a unique instance of packet 170. In other examples, the MSB size value may be signaled at a higher level, e.g., at a level of a group of blocks, or a slice, a frame, or multiple frames. In one example, MSB size syntax element 176 may take an integer value between 0 and a full bit-depth value for the pixels of the block.

In this example, payload 180 includes MSB data 182 and LSB data 184. It is assumed for purposes of example and illustration that payload 180 includes compressed data for MSB data 182. That is, MSB data 182 may include VLC codewords representing non-zero residual pixel values and run values indicating a number of zero-valued pixels in coding order until the next non-zero residual pixel. LSB data 184 is shown in broken lines to indicate that LSB data 184 is optional. When included, LSB data 184 may include the uncompressed LSBs themselves, or data representing a location of the corresponding LSBs, such as pointers including memory addresses of the LSBs.

Alternatively, when the value of compression syntax element 174 indicates that the MSBs are not compressed, payload 180 may include either uncompressed data for the block or one or more pointers that include memory addresses for the uncompressed data for the block. In the uncompressed case, payload 180 would not include separate MSBs data 182 and LSBs data 184.

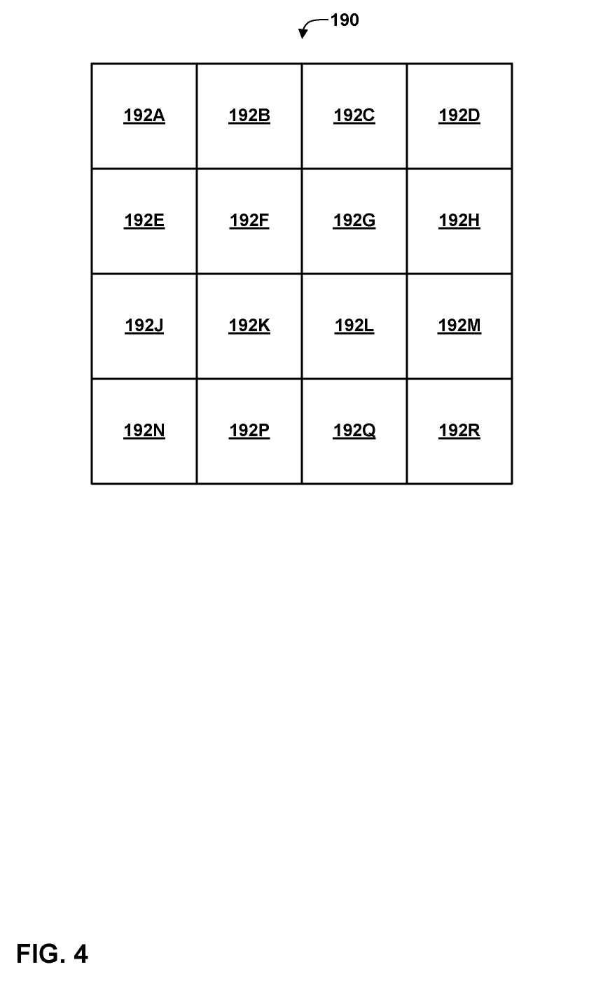

FIG. 4 is a conceptual diagram illustrating block 190 of residual values 192A-192R (residual values 192). In one example, residual coding unit 118 may code residual values 192 in a raster scan order. That is, residual coding unit 118 may code the residual values in the following order: residual value 192A, residual value 192B, residual value 192C, residual value 192D, residual value 192E, residual value 192F, residual value 192G, residual value 192H, residual value 192J, residual value 192K, residual value 192L, residual value 192M, residual value 192N, residual value 192P, residual value 192Q, and residual value 192R. Alternatively, residual coding unit 118 may code residual values 192 in a different order, such as snake order. For snake order, residual coding unit 118 may code the residual values in the following order: residual value 192A, residual value 192B, residual value 192C, residual value 192D, residual value 192H, residual value 192G, residual value 192F, residual value 192E, residual value 192J, residual value 192K, residual value 192L, residual value 192M, residual value 192R, residual value 192Q, residual value 192P, and residual value 192N. In still other examples, other scan orderings may be used, such as reverse raster scan, top-to-bottom, bottom-to-top, zig-zag scan, or reverse zig-zag scan orders.

The residual value at the starting scan position may correspond to the actual pixel value. Assuming, for example, that the scan starts at residual value 192A, residual value 192A may be equal to the corresponding actual pixel value. That is, a predictor value of “0” may be used to calculate residual value 192A. Alternatively, a default predictor value may be used to predict the pixel at the position of residual value 192A.

Assuming that the scan order is raster scan order starting at residual value 192A, pixel prediction unit 114 may predict the pixel at the position of residual value 192B using residual value 192A. Likewise, pixel prediction unit 114 may predict the pixel at the position of residual value 192B using the pixel value at the position of residual value 192A, predict the pixel at the position of residual value 192C using the pixel value at the position of residual value 192B, and predict the pixel at the position of residual value 192D using the pixel value at the position of residual value 192C.

After predicting pixels in the top row (i.e., pixels at positions of residual values 192A-192D), pixel prediction unit 114 may predict values of subsequent pixels using values of above-, above-left, and/or left-neighboring pixels. For example, pixel prediction unit 114 may predict the value of the pixel at the position of residual value 192K using the values of the pixels at positions of residual values 192E, 192J, and/or 192F. Pixel prediction unit 114 may predict pixels along the left edge of block 190 (i.e., pixels 192E, 192J, 192N) using above-neighboring pixels. For example, pixel prediction unit 114 may predict pixel 192E from pixel 192A, pixel 192J from pixel 192E, and pixel 192N from pixel 192J.

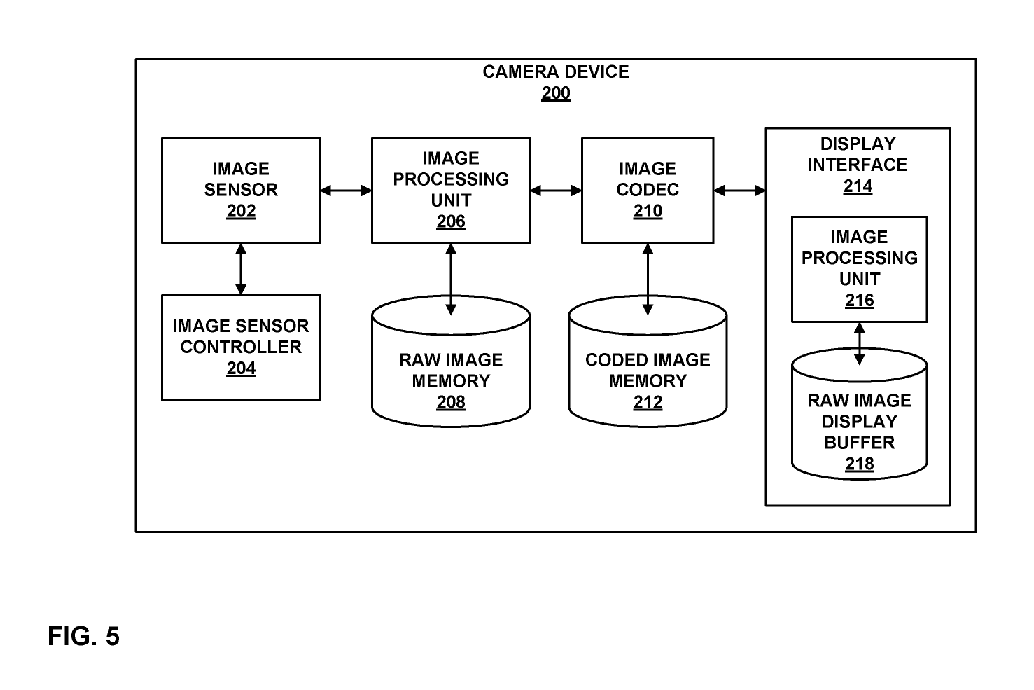

FIG. 5 is a block diagram illustrating an example camera device 200 that may use the techniques of this disclosure. In this example, camera device 200 includes image sensor 202, image sensor controller 204, image processing unit 206, raw image memory 208, image codec (encoder/decoder) 210, coded image memory 212, and display interface 214. Display interface 214 includes image processing unit 216 and raw image display buffer 218.

In general, raw image memory 208 and raw image display buffer 218 may be configured similarly to memory 102 of FIG. 1. Similarly, as discussed below, image processing unit 206 and image processing unit 216 may each be configured similarly to image processing unit 110 of FIG. 1.

Image sensor 202 includes a sensor array for capturing image data in the visible light spectrum. For example, image sensor 202 may include one or more two-dimensional arrays of sensors for capturing red, green, and blue spectra light. Image sensor controller 204 controls image sensor 202. Image sensor controller 204 may include a user interface, such as a physical or virtual (e.g., touchscreen-displayed) button. Image sensor controller 204 may determine when a user has pressed the button and, in response to the user pressing the button, cause image sensor 202 to capture an image and pass raw image data for the image to image processing unit 206.

Image processing unit 206 may be configured according to the techniques of this disclosure to store the captured image to raw image memory 208. That is, image processing unit 206 may convert the image to a set of blocks (such as block 190 of FIG. 4) including a number of pixels (arranged according to, e.g., residual values 192 of FIG. 4). Picture processing unit 206 may predict values for the pixels, e.g., using left- and/or above-neighboring pixels, and calculate residual values for the pixels as differences between the current values and the predicted values. Picture processing unit 206 may then encode MSBs of the residual values using, e.g., a lossless coding process such as run-length VLC. Picture processing unit 206 may then store the encoded MSBs and the remaining LSBs to raw image memory 208. As shown in FIG. 1, the MSBs and LSBs may be stored in separate memory regions of raw image memory 208. Such a storage scheme may be advantageous for raw image memory 208 of camera device 200, which stores the image until image codec 210 is ready to encode the image. Such encoding may be performed on a block-by-block basis.

Image codec 210 may ultimately retrieve the raw image from raw image memory 208 via image processing unit 206. Thus, in accordance with the techniques of this disclosure, image processing unit 206 may retrieve the image from raw image memory 208. In particular, image processing unit 206 may retrieve encoded MSBs for a block of the image, decode the MSBs, and concatenate the MSBs with LSBs retrieved from raw image memory 208 to reproduce residual values. Image processing unit 206 may then combine the residual values with corresponding predicted values to reproduce the pixel values of the block. Image processing unit 206 may then assemble the blocks to form all or part of the image, and pass the blocks to image codec 210.

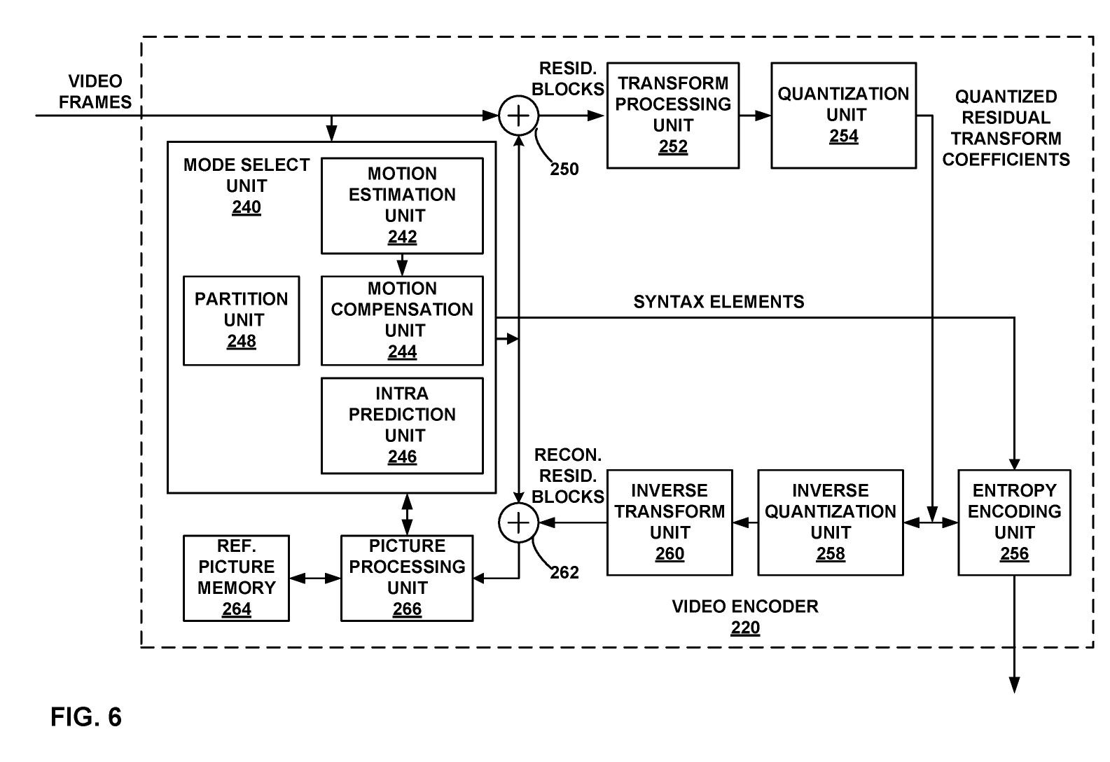

Image codec 210 may be configured to encode and decode image data according to an image coding standard, such as Joint Photographic Experts Group (JPEG). In other examples, image codec 210 may represent a video codec configured to encode and decode video data according to a video coding standard, such as ITU-T H.264/AVC (Advanced Video Coding), ITU-T H.265 (High Efficiency Video Coding), or the like. An example of a video encoder is shown in and discussed with respect to FIG. 6 below. Moreover, a separate image processing unit from image processing unit 206 may be provided within the video codec, as explained with respect to FIG. 6.

Image codec 210 may store the encoded image to coded image memory 212. Raw image memory 208 and coded image memory 212 may represent separate portions (e.g., regions) of a common memory, or physically distinct computer-readable storage media.

Display interface 214 may subsequently request access to a coded image to cause the image to be displayed, e.g., on a display of camera device 200 (not shown). Accordingly, display interface 214 may retrieve the image from coded image memory 212 via image codec 210. Image codec 210 may decode the image in preparation for display. In accordance with the techniques of this disclosure, display interface 214 may include an image processing unit 216 and a raw image display buffer 218. Image processing unit 216 may store the raw (i.e., decoded) image to raw image display buffer 218 in accordance with the techniques of this disclosure, until the image is ready to be displayed on the display. When the image is to be displayed, image processing unit 216 may retrieve the image from raw image display buffer 218 according to the techniques of this disclosure, and pass the raw image to the display.

In this manner, camera device 200 represents an example of a device for storing image data, the device comprising a memory configured to store image data, the memory comprising a first region and a second region, and one or more processing units implemented in circuitry and configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, determine whether to represent the residuals using both the MSBs and least significant bits (LSBs) of the plurality of residuals of the samples, and in response to determining not to represent the residuals using the LSBs, prevent access of the LSBs in a second region of the memory.

FIG. 6 is a block diagram illustrating an example video encoder 220 including a picture processing unit 266 that implements techniques for storing high bit depth image data in accordance with the techniques of this disclosure. As explained in greater detail below, coding of video data may include inter-prediction and/or inter-prediction of the video data. Video encoder 220 may perform intra- and inter-prediction of video blocks within video slices. Intra-mode (I mode) may refer to any of several spatial based coding modes. Inter-modes, such as uni-directional prediction (P mode) or bi-prediction (B mode), may refer to any of several temporal-based coding modes.

Intra-prediction relies on spatial prediction to reduce or remove spatial redundancy in video within a given video frame or picture. Inter-prediction relies on temporal prediction to reduce or remove temporal redundancy in video within adjacent frames or pictures of a video sequence. Picture processing unit 266 stores previously encoded and then decoded image data in reference picture memory 264, in this example. Likewise, picture processing unit 266 retrieves such previously encoded and decoded image data from reference picture memory 264, in this example. Picture processing unit 266 may correspond to image processing unit 110 of FIG. 1. Thus, picture processing unit 266 may implement the techniques of this disclosure related to encoding and storing (or retrieving and decoding) MSBs of residual pixels of raw image data and storing or retrieving corresponding LSBs of the residual pixels of the raw image data to or from reference picture memory 264.

As shown in FIG. 6, video encoder 220 receives a current video block within a video frame to be encoded. In the example of FIG. 6, video encoder 220 includes mode select unit 240, reference picture memory 264 (which may also be referred to as a decoded picture buffer (DPB)), picture processing unit 266, summer 250, transform processing unit 252, quantization unit 254, and entropy encoding unit 256. Mode select unit 240, in turn, includes motion estimation unit 242, motion compensation unit 244, intra-prediction unit 246, and partition unit 248. For video block reconstruction, video encoder 220 also includes inverse quantization unit 258, inverse transform unit 260, and summer 262. A deblocking filter (not shown in FIG. 6) may also be included to filter block boundaries to remove blockiness artifacts from reconstructed video. If desired, the deblocking filter (or other filters) would typically filter the output of summer 262.

During the encoding process, video encoder 220 receives a video frame or slice to be coded. The frame or slice may be divided into multiple video blocks, e.g., by partition unit 248. Motion estimation unit 242 and motion compensation unit 244 perform inter-predictive encoding of received video blocks relative to one or more blocks in one or more reference frames to provide temporal prediction. Intra-prediction unit 246 may alternatively perform intra-predictive encoding of received video blocks relative to pixels of one or more neighboring blocks in the same frame or slice as the block to be coded, to provide spatial prediction. Video encoder 220 may perform multiple coding passes, e.g., to select an appropriate coding mode for each block of video data. Mode select unit 240 may retrieve reference data (e.g., neighboring pixel data in the case of intra-prediction or pixel data of previously encoded and decoded images in the case of inter-prediction) from reference picture memory 264 via picture processing unit 266.

Moreover, partition unit 248 may partition blocks of video data into sub-blocks, based on evaluation of previous partitioning schemes in previous coding passes. For example, partition unit 248 may initially partition a frame or slice into coding tree units (CTUs), and partition each of the CTUs into sub-coding units (CUs) based on rate-distortion analysis (e.g., rate-distortion optimization). Mode select unit 240 may further produce a quadtree data structure indicative of partitioning of a CTU into sub-CUs. Leaf-node CUs of the quadtree may include one or more prediction units (PUs) and one or more transform units (TUs).

Mode select unit 240 may select one of the prediction modes, intra or inter, e.g., based on error results, and provides the resulting predicted block to summer 250 to generate residual data and to summer 262 to reconstruct the encoded block for use as a reference frame. Mode select unit 240 also provides syntax elements, such as motion vectors, intra-mode indicators, partition information, and other such syntax information, to entropy encoding unit 256.

Motion estimation unit 242 calculates a motion vector for a PU of a video block in an inter-coded slice by comparing the position of the PU to the position of a predictive block of a reference picture stored in reference picture memory 264. The reference picture may be selected from a first reference picture list (List 0) or a second reference picture list (List 1), each of which identify one or more reference pictures stored in reference picture memory 264. Motion estimation unit 242 sends the calculated motion vector to entropy encoding unit 256 and motion compensation unit 244.

Motion compensation, performed by motion compensation unit 244, may involve fetching or generating the predictive block from reference picture memory 264 based on the motion vector determined by motion estimation unit 242. Motion estimation unit 242 and motion compensation unit 244 may be functionally integrated, in some examples. Upon receiving the motion vector for the PU of the current video block, motion compensation unit 244 may locate the predictive block to which the motion vector points in one of the reference picture lists, and prompt mode select unit 240 to retrieve the predictive block (or data used to generate the predictive block) from reference picture memory 264 via picture processing unit 266. Summer 250 forms a residual video block by subtracting pixel values of the predictive block from the pixel values of the current video block being coded, forming pixel difference values, as discussed below. In general, motion estimation unit 242 performs motion estimation relative to luma components, and motion compensation unit 244 uses motion vectors calculated based on the luma components for both chroma components and luma components. Mode select unit 240 may also generate syntax elements associated with the video blocks and the video slice for use by a video decoder in decoding the video blocks of the video slice.

Intra-prediction unit 246 may intra-predict a current block, as an alternative to the inter-prediction performed by motion estimation unit 242 and motion compensation unit 244, as described above. In particular, intra-prediction unit 246 may determine an intra-prediction mode to use to encode a current block. In some examples, intra-prediction unit 246 may encode a current block using various intra-prediction modes, e.g., during separate encoding passes, and intra-prediction unit 246 (or mode select unit 240, in some examples) may select an appropriate intra-prediction mode to use from the tested modes. After selecting an intra-prediction mode for a block, intra-prediction unit 246 may provide information indicative of the selected intra-prediction mode for the block to entropy encoding unit 256.

Video encoder 220 forms a residual video block by subtracting the prediction data generated by mode select unit 240 from the original video block being coded. Summer 250 represents the component or components that perform this subtraction operation. Transform processing unit 252 applies a transform, such as a discrete cosine transform (DCT) or a conceptually similar transform, to the residual block, producing a video block comprising transform coefficient values. The transform may convert the residual information from a pixel domain to a transform domain, such as a frequency domain. Transform processing unit 252 may send the resulting transform coefficients to quantization unit 254. Quantization unit 254 quantizes the transform coefficients to further reduce bit rate. The quantization process may reduce the bit depth associated with some or all of the coefficients. The degree of quantization may be modified by adjusting a quantization parameter.

Following quantization, entropy encoding unit 256 entropy encodes the quantized transform coefficients. For example, entropy encoding unit 256 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 256, the encoded bitstream may be transmitted to another device or archived for later transmission or retrieval.

Inverse quantization unit 258 and inverse transform unit 260 apply inverse quantization and inverse transformation, respectively, to reconstruct the residual block in the pixel domain. In particular, summer 262 adds the reconstructed residual block to the motion compensated prediction block earlier produced by motion compensation unit 244 or intra-prediction unit 246 to produce a reconstructed video block for storage in reference picture memory 264 via picture processing unit 266. The reconstructed video block may be used by motion estimation unit 242 and motion compensation unit 244 as a reference block to inter-code a block in a subsequent video frame, or by intra-prediction unit 246 to intra-predict a subsequent block of a current video frame.

It should be understood that picture processing unit 266 may operate according to the techniques of this disclosure when accessing picture data stored in reference picture memory 264. For example, when picture processing unit 266 receives decoded image data from summer 262, picture processing unit 266 may store the decoded image data to reference picture memory 264 by predicting and then calculating residuals for pixels of the image data (e.g., for one or more blocks of image data, similar to block 190 of FIG. 4). Picture processing unit 266 may then determine whether the image data can be compressed, and if so, separate the residual values into MSBs and LSBs, store an indication (e.g., a value for a syntax element) of whether the MSBs are compressed, a size of the MSBs, and compressed data for the MSBs and the uncompressed LSBs.

Likewise, picture processing unit 266 may retrieve image data from reference picture memory 264 by determining whether a block includes compressed MSBs, and if so, sizes of the MSBs, then decompress the MSBs, concatenate the MSBs with corresponding LSBs, add the concatenated MSBs and LSBs to predicted data, and thereby regenerate the image data. In this manner, picture processing unit 266 may reduce bandwidth consumption when accessing (e.g., storing data to or retrieving data from) reference picture memory 264.

It should be understood that the encoding and decoding process performed by picture processing unit 266 is separate from the encoding and decoding process performed by video encoder 220, e.g., by mode select unit 240, summer 250, transform processing unit 252, quantization unit 254, inverse quantization unit 258, inverse transform unit 260, and summer 262. Thus, predicted values, residual values, and reconstructed values calculated by picture processing unit 266 are distinct from predicted values, residual values, and reconstructed values calculated by, e.g., mode select unit 240, summer 250, and summer 262, and serve different purposes.

In this example, picture processing unit 266 is separate from other units of video encoder 220. In other examples, picture processing unit 266 may be incorporated into, e.g., mode select unit 240.

Furthermore, although only one picture processing unit 266 is shown in this example, in other examples, one or more additional picture processing units similar to picture processing unit 266 may be incorporated into video encoder 220. For example, a similar picture processing unit and picture memory may be used to store input raw image data provided to mode select unit 240 and summer 250 (that is, along the input line marked “VIDEO FRAMES”).

In this manner, video encoder 220 of FIG. 6 represents an example of a device for storing image data, the device comprising a memory configured to store image data, the memory comprising a first region and a second region, and one or more processing units implemented in circuitry and configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, determine whether to represent the residuals using both the MSBs and least significant bits (LSBs) of the plurality of residuals of the samples, and in response to determining not to represent the residuals using the LSBs, prevent access of the LSBs in a second region of the memory.

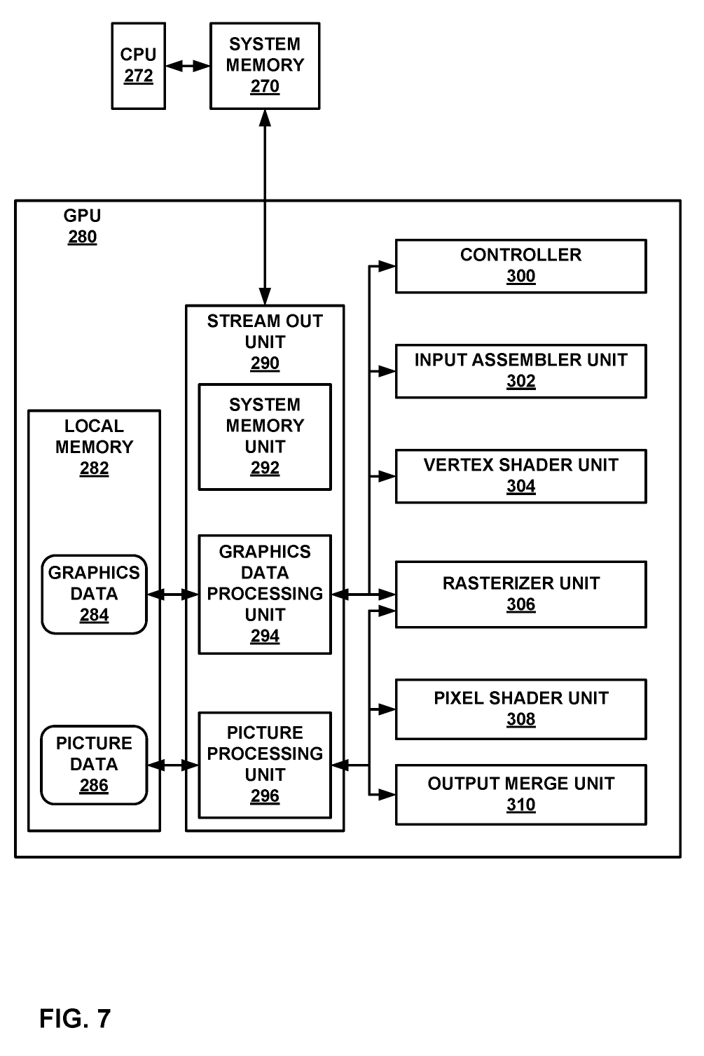

FIG. 7 is a block diagram illustrating an example of a graphics processing unit (GPU) 280 including a picture processing unit that implements techniques for storing high bit depth image data in accordance with the techniques of this disclosure. To perform graphics operations, GPU 280 may implement a graphics processing pipeline. The graphics processing pipeline includes one or more units that perform functions as defined by software or firmware executing on GPU 280 and fixed-function units that are hardwired to perform very specific functions. The software or firmware executing on the GPU 280 may be referred to as shaders, and the shaders may execute on one or more shader cores of GPU 280. Shaders provide users with functional flexibility because a user can design the shaders to perform desired tasks in any conceivable manner. The fixed-function units, however, are hardwired for the manner in which the fixed-function units perform tasks.

In this example, GPU 280 includes input assembler unit 302, vertex shader unit 304, rasterizer unit 306, pixel shader unit 308, and output merge unit 310. GPU 280 may include addition units such a hull shader unit, tessellation unit, and/or domain shader unit (not shown in the example of FIG. 7) that follow vertex shader unit 304, in that order. GPU 280 may also include a geometry shader unit (not shown) coupled to the output of the domain shader unit, if GPU 280 includes a domain shader unit, or the output of the vertex shader unit 304, if GPU 280 does not include the domain shader unit. Rasterizer unit 306 may receive graphics data from vertex shader unit 304, as illustrated, or from a geometry shader unit (when available) or a domain shader unit (when available).

Other configurations of the graphics pipeline are possible, and the techniques described in this disclosure should not be considered limited to the specific example illustrated in FIG. 7. For example, GPU 280 may include more units than those illustrated, and in some examples, GPU 280 may not necessarily include all of the illustrated units. Also, the specific ordering of the units is provided for purposes of illustration and should not be considered limiting.

Input assembler unit 302 may read vertex points of vertices from system memory 270 as defined by CPU 272, and assemble control points to form vertices. For instance, input assembler unit 302 may read vertex point coordinates, color values, and other such information. The coordinates, color values, and other such information may be commonly referred to as attributes of the vertices. Based on the attributes of the vertices, input assembler unit 302 may determine the general layout of graphical primitives (e.g., triangles). In this manner, input assembler unit 302 may assemble the control points to form the patch. Input assembler unit 302 may be a fixed-function unit. Input assembler unit 302 may store data for the vertices as graphics data 284 in local memory 282 via graphics data processing unit 294 of stream out unit 290.

Vertex shader unit 304 may process the data for the vertices from input assembler unit 302. For example, vertex shader unit 304 may retrieve the data for the vertices from graphics data 284 of local memory 282 via graphics data processing unit 294. Vertex shader unit 304 may then perform per-vertex operations such as transformations, skinning, morphing, and per-vertex lighting. Vertex shader unit 304 may then store the resulting data for the vertices as part of graphics data 284 to local memory 282 via graphics data processing unit 294. Vertex shader unit 304 may be a shader.

Rasterizer unit 306 retrieves the data (e.g., graphics primitives) stored by vertex shader unit 304 from graphics data 284 of local memory 282 via graphics data processing unit 294. Rasterizer unit 306 may then convert the primitives into pixels for display. For example, the primitives may be defined as a set of interconnected vectors, and may be defined in a coordinate space that is independent of the display on which the image is to be displayed. Rasterizer unit 306 converts these vectors into display coordinates, and performs any additional functions, such as removing points within primitives that are occluded. Rasterizer unit 306 stores the resulting generated image as picture data 286 via picture processing unit 296.

Picture processing unit 296 may include components substantially similar to those of image processing unit 110 of FIG. 1. Picture processing unit 296 may be configured to perform the techniques of this disclosure. That is, picture processing unit 296 may receive an image from, e.g., rasterizer unit 306. Picture processing unit 296 may convert the image to a set of blocks (such as block 190 of FIG. 4) including a number of pixels (such as residual values 192 of FIG. 4). Picture processing unit 296 may predict values for the pixels, e.g., using left- and/or above-neighboring pixels, and calculate residual values for the pixels as differences between the current values and the predicted values. Picture processing unit 296 may then encode MSBs of the residual values using, e.g., a lossless coding process such as run-length VLC. Picture processing unit 296 may then store the encoded MSBs and the remaining LSBs as picture data 286 of local memory 282. As shown in FIG. 1, the MSBs and LSBs may be stored in separate memory regions. However, in the example of FIG. 7, it would typically be the case that an entire image would be accessed (e.g., stored or retrieved), and thus, the MSBs and LSBs may be stored together in this example.

Subsequently, pixel shader unit 308 may retrieve the rasterized image generated by rasterizer unit 306. In particular, pixel shader unit 308 may retrieve the image from picture data 286 via picture processing unit 296. Thus, picture processing unit 296 may retrieve each block of the image, decode MSBs of residual values for the block, and concatenate the decoded MSBs with respective LSBs of the residual values. Picture processing unit 296 may then add the residual values to corresponding predicted values for the pixels to regenerate the block. Picture processing unit 296 may perform this process for each block of the image to reconstruct the image, and then pass the image to pixel shader unit 208.

Pixel shader unit 308 post-processes pixels of the retrieved image to assign color values to each of the pixels that are to be displayed. For example, pixel shader unit 308 may receive constant values stored in system memory 270, texture data stored in system memory 270, and any other data to generate per-pixel outputs, such as color values. Pixel shader unit 308 may also output opacity values that indicate the opaqueness of the pixels. Pixel shader unit 308 may store the shaded image as picture data 286 via picture processing unit 296, which again may losslessly encode MSBs of residual values and store the encoded MSBs and corresponding LSBs as discussed above as picture data 286.

Output merge unit 310 may perform any final pixel processing on the post-processed image stored in picture data 286. In particular, output merge unit 310 may retrieve the post-processed image from picture data 286 via picture processing unit 296, which again may decode the MSBs of residual values for blocks of the image and reassemble the image as discussed above. Output merge unit 310 may use depth information to further determine whether any of the pixels should not be displayed. Output merge unit 310 may also perform blending operations to generate final pixel values. Output merge unit 310 may output the final pixel values to a frame buffer, generally located within system memory 270, but which may be located within GPU 280.

In the example illustrated in FIG. 7, each one of the units receives data from and outputs data to local memory 282 of GPU 280 via graphics data processing unit 294 or picture processing unit 296. Other examples of local memory exist in addition to or instead of local memory 282. As one example, the units may output data to and receive data from general purpose registers (GPRs). Unlike local memory 282, each of the GPRs may be configured to receive from and output to specific units, rather than being memory for each of the units. GPRs are another example of local memory of GPU 280.

Local memory 282 of GPU 280 stores intermediate data generated by respective units for subsequent retrieval of the intermediate data by the next unit for further processing. For example, input assembler unit 302 retrieves graphics data 284 of local memory 282, performs graphics processing on the retrieved graphics data, and generates first intermediate data that input assembler unit 302 stores in local memory 282 via graphics data processing unit 294. Vertex shader unit 304 retrieves this first intermediate data from local memory 282 via graphics data processing unit 294, performs graphics processing on this retrieved intermediate data, and generates second intermediate data, which vertex shader unit 304 stores as graphics data 284 via graphics data processing unit 294.

Furthermore, rasterizer unit 306, pixel shader unit 308, and output merge unit 310 access (e.g., store and/or retrieve) picture data 286 via picture processing unit 296, which again operates according to the techniques of this disclosure, as discussed above. In this manner, GPU 280 represents an example of a device for storing image data, the device comprising a memory configured to store image data, the memory comprising a first region and a second region; and one or more processing units configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, and access least significant bits (LSBs) of the plurality of residuals of the samples in the second region of the memory.

As illustrated, GPU 280 includes stream out unit 290 which is a hardware unit of GPU 280. That is, stream out unit 290 may be implemented using one or more physical processing units, e.g., processing units implemented using fixed and/or programmable logic circuitry. Stream out unit 290 may be configured to receive data from local memory 282, and more particularly, data generated by the graphics processing pipeline, and output that data to system memory 270. Stream out unit 290 may also be configured to receive data from system memory 270 and store the data in local memory 282 (e.g., after the preemption is complete and the original instructions are to execute). Accordingly, stream out unit 290 provides a specialized way for GPU 280 to output intermediate data (e.g., data generated by the geometry pipeline) to system memory 270 and to retrieve this intermediate data from system memory 270.

Although only a single picture processing unit 296 is shown that accesses (e.g., stores and retrieves) data of local memory 282, it should be understood that in other examples, GPU 280 may include or interact with one or more additional picture processing units similar to picture processing unit 296. For example, a picture processing unit that performs the techniques of this disclosure may be provided within stream out unit 290 that accesses (e.g., stores and/or retrieves) image data of system memory 270. Alternatively, this picture processing unit may be positioned between GPU 280 and system memory 270. Additionally or alternatively, a picture processing unit may be included within stream out unit 290, or separate from GPU 280, that receives a rendered image from output merge unit 310 to be displayed (e.g., as part of a display buffer of a device including GPU 280).

In this manner, GPU 280 of FIG. 7 represents an example of a device for storing image data, the device comprising a memory configured to store image data, the memory comprising a first region and a second region, and one or more processing units implemented in circuitry and configured to code most significant bits (MSBs) of a plurality of residuals of samples of a block of an image, each of the residuals representing a respective difference value between a respective raw sample value and a respective predicted value for the respective raw sample value, access the coded MSBs in the first region of the memory, determine whether to represent the residuals using both the MSBs and least significant bits (LSBs) of the plurality of residuals of the samples, and in response to determining not to represent the residuals using the LSBs, prevent access of the LSBs in a second region of the memory.

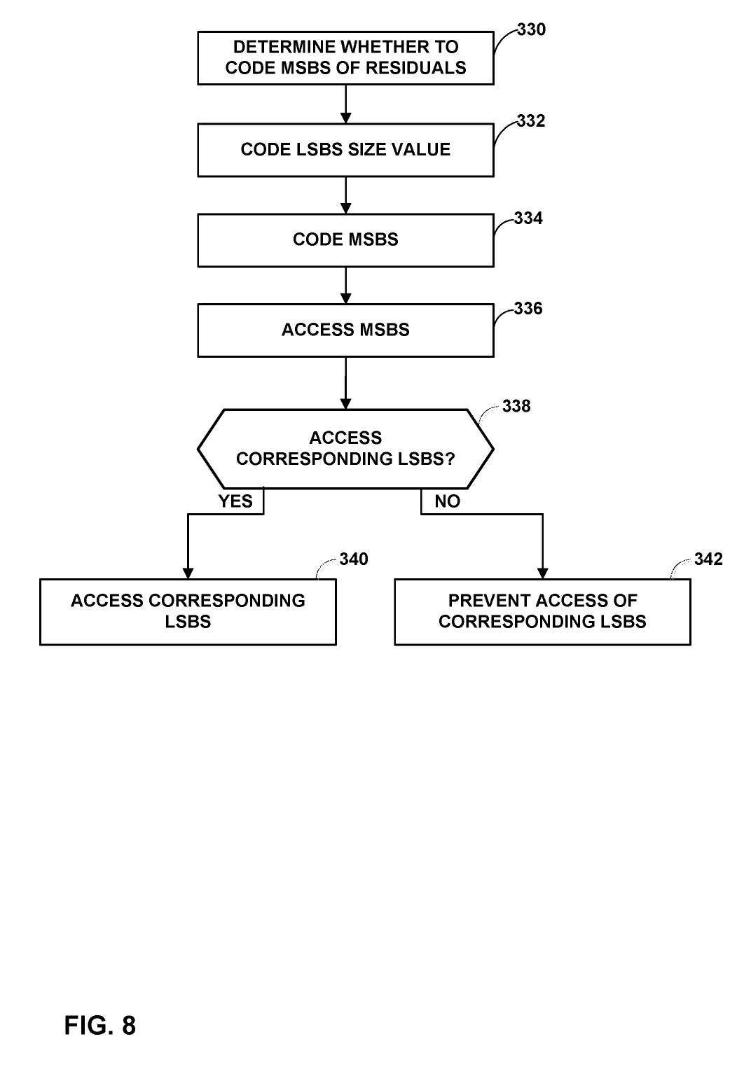

FIG. 8 is a conceptual diagram illustrating an example method of coding a block of image data in accordance with the techniques of this disclosure. In general, the method of FIG. 8 represents coding in terms of both encoding and decoding. The method of FIG. 8 is explained with respect to the example of image processing unit 110 of FIG. 1. However, it should be understood that the other various image processing units of this disclosure (such as image processing units 206 and 216 of FIG. 5, picture processing unit 266 of FIG. 6, and picture processing unit 296 of FIG. 7), and other similar units, may be similarly configured to perform this or a similar method.

In this example, image processing unit 110 initially determines whether to code MSBs of a plurality of residual values (330) for a block of pixels. For example, when encoding and storing, image processing unit 110 may compare a number of coding bits used to represent coded MSBs values to a number of bits used to represent uncoded MSBs values, and determine whether or not to store the coded MSBs values based on this comparison. Also, when encoding and storing, image processing unit 110 may code a value for a compression syntax element indicating whether the MSBs are coded (e.g., a value for compression syntax element 174 of FIG. 3). When decoding and retrieving, image processing unit 110 may determine whether the value of a syntax element indicates that the MSBs are coded (e.g., the value for compression syntax element 174 of FIG. 3).

Assuming image processing unit 110 determines to code the MSBs, image processing unit 110 further codes an LSBs size value (332). For example, the LSBs size value may correspond to the difference between a bit depth and the value of MSB size syntax element 176. Alternatively, the LSBs size value may be stored in place of MSB size syntax element 176. The LSB size value represents a size, in terms of bits, of the LSBs for residual values of the block. The LSB size value may correspond to num_lsb_bits discussed above.

Image processing unit 110 may then code the MSBs (334). For example, when encoding and storing, image processing unit 110 encodes the MSBs, e.g., using run-length coding using VLC. Furthermore, when encoding and storing, prior to coding the MSBs, image processing unit 110 calculates the residual values and partitions the residual values into the MSBs and the LSBs (not shown in FIG. 8). When decoding and retrieving, image processing unit 110 decodes the MSBs, e.g., using run-length coding using VLC. Furthermore, when decoding and retrieving, after coding the MSBs, image processing unit 110 concatenates the MSBs with the corresponding LSBs to reproduce the residual values, which image processing unit 110 combines with predicted values to reproduce the pixel values.

In the example of FIG. 8, after coding the MSBs, image processing unit 110 accesses the MSBs (336). Image processing unit 110 also determines whether to access the corresponding LSBs (338). In particular, “accessing” may refer to storing or retrieving. When encoding and storing, image processing unit 110 stores the MSBs to compressed MSB region 104 of memory 102 and, in response to determining to store the LSBs, stores the LSBs to LSB region 106 of memory 102. When decoding and retrieving, steps 336 and 338 would come before step 334, and image processing unit 110 would retrieve the MSBs from compressed MSB region 104 of memory 102 and, if the LSBs are to be accessed, retrieves the LSBs from LSB region 106 of memory 102.

In accordance with the techniques of this disclosure, image processing unit 110 determines whether to access the corresponding LSBs (338). In particular, image processing unit 110 may determine whether to code a block in a lossy mode or in a lossless mode. That is, the determination at step 338 may in fact be a determination of whether to represent residual values of a block of an image using both the MSBs and the LSBs of the residual values. When coding the block in a lossy mode, image processing unit 110 may determine not to access (use) the LSBs, e.g., not to store/retrieve the LSBs, or simply not to use the LSBs during decoding. When coding the block in a lossless mode, image processing unit 110 may determine to access (use) the LSBs, e.g., to store/retrieve the LSBs and to use the LSBs during decoding.

In the example of FIG. 8, in response to determining to access the corresponding LSBs (“YES” branch of 338), image processing unit 110 accesses the corresponding LSBs (340). For example, when encoding, image processing unit 110 may store the LSBs to LSB region 106. Similarly, when decoding, image processing unit 110 may retrieve the LSBs from LSB region 106 and use the LSBs when reproducing a pixel value in a lossless mode, e.g., according to algorithm (3) above. On the other hand, in response to determining not to access the corresponding LSBs (“NO” branch of 338), image processing unit 110 may prevent access of the corresponding LSBs (342). For example, when encoding, image processing unit 110 may discard the LSBs without storing the LSBs to memory 102. In some examples, following encoding, image processing unit 110 may still store the LSBs even when the LSBs are not expected to be used during decoding, in case a subsequent decision to use the LSBs during decoding is made at decode time. When decoding, image processing unit 110 may avoid retrieval of the LSBs, and instead, decode and reconstruct pixel values of a block using only the MSBs and the number of LSBs, without using the LSBs themselves.

In this manner, the method of FIG. 8 represents an example of a method of accessing image data, the method comprising coding most significant bits (MSBs) of a plurality of residuals of samples of a block of an image, each of the residuals representing a respective difference value between a respective raw sample value and a respective predicted value for the respective raw sample value, accessing the coded MSBs in a first region of a memory, determining whether to represent the residuals using both the MSBs and least significant bits (LSBs) of the plurality of residuals of the samples, and in response to determining not to represent the residuals using the LSBs, preventing access of the LSBs in a second region of the memory.

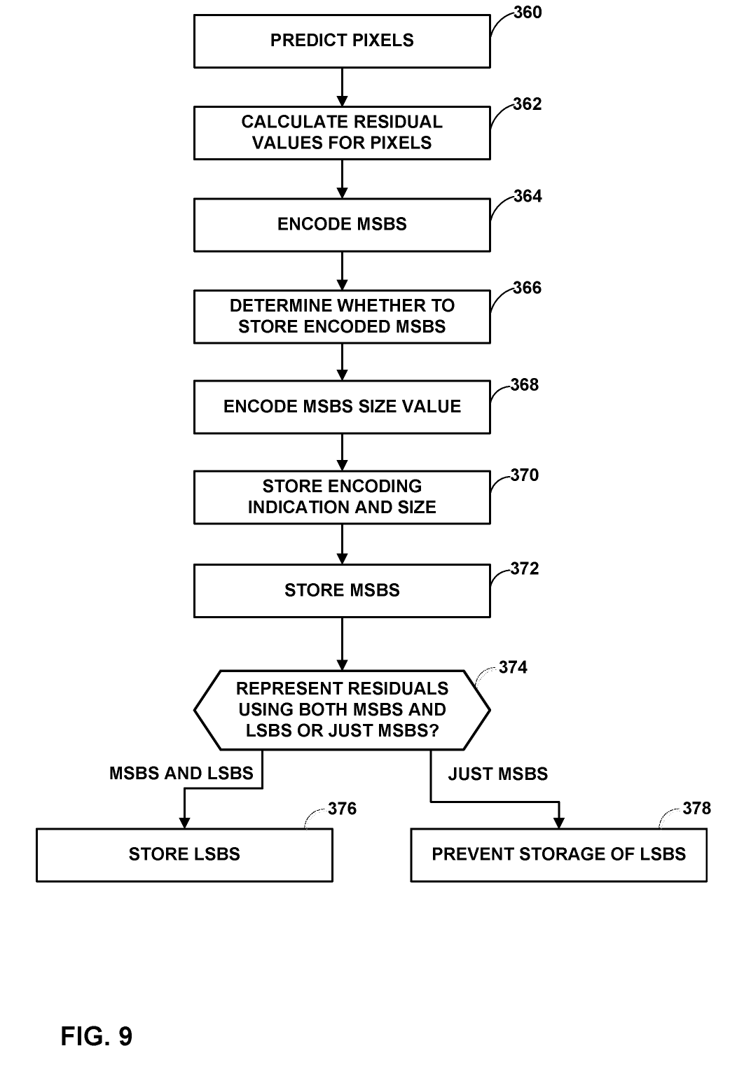

FIG. 9 is a conceptual diagram illustrating an example method for encoding a block of image data in accordance with the techniques of this disclosure. The method of FIG. 9 is explained with respect to the example of image processing unit 110 of FIG. 1. However, it should be understood that the other various image processing units of this disclosure (such as image processing units 206 and 216 of FIG. 5, picture processing unit 266 of FIG. 6, and picture processing unit 296 of FIG. 7), and other similar units, may be similarly configured to perform this or a similar method.

It is assumed that image processing unit 110 initially partitions a received image into blocks. Image processing unit 110 may perform the method of FIG. 9 on each block of the image. Image processing unit 110 may predict pixels of the block (360). For example, as discussed with respect to FIG. 4, image processing unit may predict pixels using reproduced values of left-, above-left-, and/or above-neighboring pixel values. The use of left-, above-left-, and/or above-neighboring pixel values is assumed for raster scan order of the pixels. In general, pixel values that have previously been coded (encoded and then decoded) may be used for prediction. Accordingly, for other scan orders, other pixels may be used for prediction. For example, for snake scan ordering, above-neighboring, left-neighboring, above-left-neighboring, above-right-neighboring, and/or right-neighboring pixel values may be used for prediction, based on the position of the pixel being predicted and whether the pixel is in a row that is being left-scanned or right-scanned (that is, having left-neighboring pixels or right-neighboring pixels that were previously scanned and coded).

Image processing unit 110 may then calculate residual values for the pixels (362). In particular, image processing unit 110 may calculate differences between the original values for the pixels and the predicted values for the pixels. In this manner, image processing unit 110 may produce residual values for each of the pixels of the block.

Image processing unit 110 may then encode MSBs of the residual values (364). For example, image processing unit 110 may determine a number of bits for the residual values to treat as MSBs, and then use a lossless coding technique, such as run-length coding using VLC, to encode the MSBs.

After encoding the MSBs, image processing unit 110 may determine whether to store the encoded MSBs values (366). For example, image processing unit 110 may compare a number of bits used to represent the encoded MSBs to a number of bits used to represent the uncoded MSBs. If the number of bits used to represent the encoded MSBs is less than the number of bits used to represent the uncoded MSBs (or the number of bits used to represent the uncoded MSBs minus a threshold value), image processing unit 110 may determine to store the encoded MSBs. Otherwise, image processing unit 110 may store uncoded data for the block instead of encoded MSBs.

Assuming that image processing unit 110 determines to store the encoded MSBs, image processing unit 110 may encode an LSBs size value (368). The LSBs size value represents a number of bits included in LSBs for residuals of the block, which is the difference between a bit depth of the residuals and the number of MSBs of the residuals.

Likewise, image processing unit 110 may then store the encoding indication and the size value (370). Image processing unit 110 may also store the MSBs (372). For example, image processing unit 110 may store this data in compressed MSB region 104 of memory 102, in a form similar to packet 170 of FIG. 3.

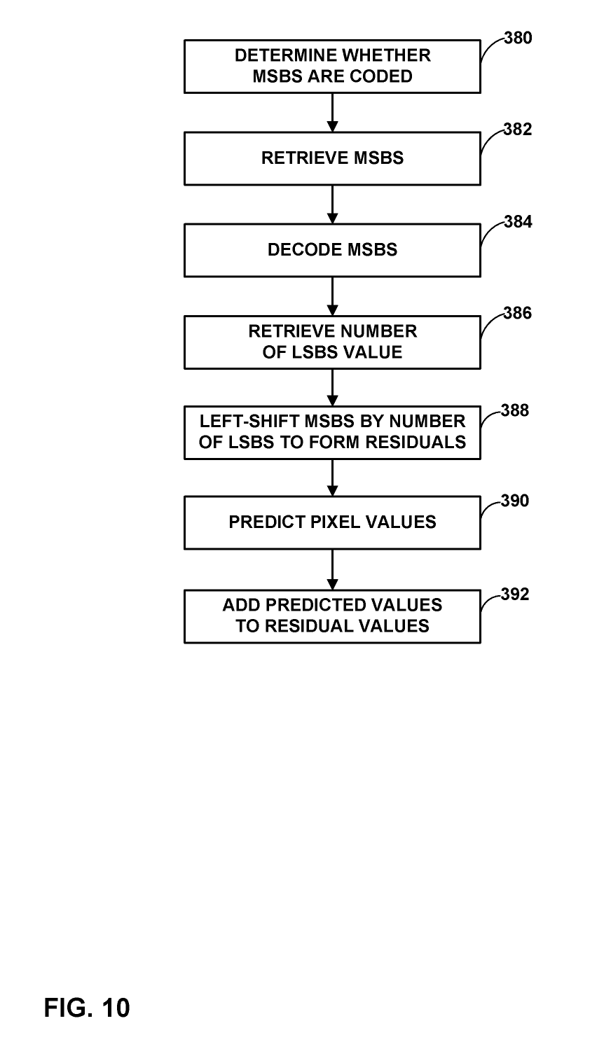

In addition, according to the techniques of this disclosure, image processing unit 110 may determine whether to represent the residual values using both the MSBs and the LSBs, or just the MSBs (374). For example, if a corresponding image processing pipeline can effectively render the image data and support lossiness, image processing unit 110 may determine to represent the residuals using just the MSBs, thereby encoding the image data in a lossy mode. In response to determining to represent the residuals using both the MSBs and LSBs (“MSBs and LSBs” branch of 374), image processing unit 110 may store the LSBs (376) to LSBs region 106 of memory 102. In response to determining to represent the residuals using just the MSBs (“just MSBs” branch of 374), image processing unit 110 may prevent storage of the LSBs (378). Alternatively, in some examples, image processing unit 110 may still store the LSBs following the encoding process even after determining to represent the residual using just the MSBs, but during a corresponding decoding process (e.g., as discussed with respect to FIG. 10 below), prevent retrieval of the LSBs.

In this manner, the method of FIG. 9 represents an example of a method of accessing image data, the method comprising coding (specifically, encoding) most significant bits (MSBs) of a plurality of residuals of samples of a block of an image, each of the residuals representing a respective difference value between a respective raw sample value and a respective predicted value for the respective raw sample value, accessing (storing) the coded MSBs in a first region of a memory, determining whether to represent the residuals using both the MSBs and least significant bits (LSBs) of the plurality of residuals of the samples, and in response to determining not to represent the residuals using the LSBs, preventing access (storage, and/or subsequent retrieval) of the LSBs in a second region of the memory.

FIG. 10 is a conceptual diagram illustrating an example method for decoding a block of image data in accordance with the techniques of this disclosure. The method of FIG. 10 is explained with respect to the example of image processing unit 110 of FIG. 1. However, it should be understood that the other various image processing units of this disclosure (such as image processing units 206 and 216 of FIG. 5, picture processing unit 266 of FIG. 6, and picture processing unit 296 of FIG. 7), and other similar units, may be similarly configured to perform this or a similar method.

In this example, it is assumed that image processing unit 110 has determined to represent residuals of the block using only most significant bits (MSBs) of the residuals, without using corresponding least significant bits (LSBs) of the residuals. That is, in this example, it is assumed that image processing unit 110 has determined to decode the block in a lossy mode. In other examples, image processing unit 110 may determine to instead decode the block in a lossless mode, and perform a modified version of the method of FIG. 10, e.g., according to algorithm (3) above.

Initially, image processing unit 110 determines whether MSBs of residual values of a block of an image are coded (380). For example, image processing unit 110 may retrieve a value for a compression syntax element, such as compression syntax element 174 (FIG. 3), indicating whether the MSBs of the residual values for the block are coded. In the example of FIG. 10, it is assumed that the MSBs are coded.

Accordingly, image processing unit 110 retrieves the MSBs (382). For example, image processing unit 110 may retrieve the MSBs from compressed MSB region 104 of memory 102. The retrieved MSBs data may further include pointers to corresponding LSBs, or the LSBs themselves.

Image processing unit 110 may then decode the MSBs (384). For example, image processing unit 110 may determine the value of a VLC codeword, then determine a corresponding MSBs residual value and a run value indicating a number of MSBs in scan order having the same MSBs residual value.

Image processing unit 110 may also retrieve a number of LSBs value (386), representing a number of LSBs that formed the full residual value. The number of LSBs value may correspond to num_lsb_bits as discussed above.

Image processing unit 110 may then left-shift the MSBs by the number of LSBs value to reconstruct the residual values for the pixels (388). Image processing unit 110 may further predict the pixel values (390), e.g., using left-, above-left-, and/or above-neighboring pixel values that were previously reconstructed. Image processing unit 110 may further add the predicted values to the corresponding residual values to reconstruct the full pixel values (392), albeit not matching the original pixel values due to the lossy coding mode. In particular, image processing unit 110 may reconstruct each pixel value in scan order, such that the pixels are available for prediction of subsequent pixels of the block.

In this manner, the method of FIG. 10 represents an example of a method of storing image data, the method comprising coding (specifically, decoding) most significant bits (MSBs) of a plurality of residuals of samples of a block of an image, each of the residuals representing a respective difference value between a respective raw sample value and a respective predicted value for the respective raw sample value, accessing (retrieving) the coded MSBs in a first region of a memory, determining whether to represent the residuals using both the MSBs and least significant bits (LSBs) of the plurality of residuals of the samples, and in response to determining not to represent the residuals using the LSBs, preventing access of (retrieval of) the LSBs in a second region of the memory.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of accessing image data, the method comprising:
coding most significant bits (MSBs) of a plurality of residuals of samples of a block of an image, each of the residuals representing a respective difference value between a respective raw sample value and a respective predicted value for the respective raw sample value;
accessing the coded MSBs in a first region of a memory;
determining whether to represent the residuals using both the MSBs and least significant bits (LSBs) of the plurality of residuals of the samples; and
in response to determining not to represent the residuals using the LSBs, preventing access of the LSBs in a second region of the memory.

2. The method of claim 1, further comprising, in response to determining to represent the residuals using the LSBs, accessing the LSBs in the second region of the memory.

3. The method of claim 1, further comprising determining a number of bits in the LSBs.

4. The method of claim 3, further comprising calculating a number of bits in the MSBs as being equal to a bit depth of the residuals minus the number of bits in the LSBs.

5. The method of claim 3, wherein determining the number of bits in the LSBs comprises:
calculating a magnitude value for the residuals; and
determining the number of bits in the LSBs based on whether the magnitude value is above or below a threshold value.

6. The method of claim 5, further comprising:
calculating a luminance level for the block, the luminance level comprising an average pixel value for pixels of the block; and
determining the threshold value using the luminance level.

7. The method of claim 3, wherein determining the number of bits in the LSBs comprises:
calculating a magnitude value for the residuals;
determining an initial number of LSBs value;
determining that the number of LSBs is equal to the initial number of LSBs value when the magnitude value is less than a first threshold value;
determining that the number of LSBs is equal to the initial number of LSBs value plus one when the magnitude value is less than a second threshold value, wherein the second threshold value is larger than the first threshold value;
determining that the number of LSBs is equal to the initial number of LSBs value plus three when the magnitude value is greater than a third threshold value, wherein the third threshold value is larger than the second threshold value; and
determining that the number of LSBs is equal to the initial number of LSBs value plus two when the magnitude value is greater than the second threshold value and less than the third threshold value.

8. The method of claim 1, wherein coding the MSBs comprises encoding the MSBs, wherein accessing the coded MSBs comprises storing the encoded MSBs, the method further comprising calculating the respective difference values between the respective raw sample values and the respective predicted values.

9. The method of claim 8, wherein each of the residuals comprises a residual value and a sign value representing whether the residual value is positive or negative, the method further comprising, for each of the residuals:
setting an offset value according to an image characteristic when the number of LSBs is greater than one;
setting the offset value equal to zero when the number of LSBs is less than or equal to one;
calculating a temporary MSBs value for a current residual of the residuals as being equal to the sign value for the current residual multiplied by a sum of an absolute value of the residual value for the current residual plus the offset value, the sum right-shifted by the number of LSBs;
calculating a max value as being equal to one left-shifted by a bit depth for the block, minus one; and
calculating an MSB value for the current residual as being equal to CLIP3(−(predictor value for the current residual right shifted by the number of LSBs), (max value minus the predictor value) right shifted by the number of LSBs, the temporary MSB value), wherein CLIP3(a, b, x)=Max(a, Min (b, x)).

10. The method of claim 9, further comprising, for each of the residuals, calculating an LSB value for the current residual as being equal to the residual value for the current residual minus the MSB value for the current residual left-shifted by the number of LSBs.

11. The method of claim 1, wherein accessing the coded MSBs comprises retrieving encoded MSBs, and wherein coding the MSBs comprises decoding the encoded MSBs to reproduce the MSBs, the method further comprising:
in response to determining not to represent the residuals using the LSBs:
determining a number of bits in the LSBs;
left-shifting the reproduced MSBs by the number of bits in the LSBs to reproduce a decoded version of the residuals of the samples of the block; and
adding the respective predicted values to the decoded version of the residuals.

12. The method of claim 1, further comprising determining the predicted value of a current sample using a reproduced value of at least one of a left-neighboring sample, an above-left neighboring sample, or an above-neighboring sample to the current sample.

13. A device for accessing image data, the device comprising:
a memory configured to store image data, the memory comprising a first region and a second region; and
one or more processing units implemented in circuitry and configured to:
code most significant bits (MSBs) of a plurality of residuals of samples of a block of an image, each of the residuals representing a respective difference value between a respective raw sample value and a respective predicted value for the respective raw sample value;
access the coded MSBs in the first region of the memory;
determine whether to represent the residuals using both the MSBs and least significant bits (LSBs) of the plurality of residuals of the samples; and
in response to determining not to represent the residuals using the LSBs, prevent access of the LSBs in a second region of the memory.

14. The device of claim 13, wherein the one or more processing units are configured to, in response to determining to represent the residuals using the LSBs, access the LSBs in the second region of the memory.

15. The device of claim 13, wherein the one or more processing units are configured to, determine a number of bits in the LSBs.

16. The device of claim 15, wherein the one or more processing units are configured to calculate a number of bits in the MSBs as being equal to a bit depth of the residuals minus the number of bits in the LSBs.

17. The device of claim 15, wherein to determine the number of bits in the LSBs, the one or more processing units are configured to:
calculate a magnitude value for the residuals; and
determine the number of bits in the LSBs based on whether the magnitude value is above or below a threshold value.

18. The device of claim 17, wherein the one or more processing units are further configured to:
calculate a luminance level for the block, the luminance level comprising an average pixel value for pixels of the block; and
determine the threshold value using the luminance level.

19. The device of claim 15, wherein to determine the number of bits in the LSBs, the one or more processing units are configured to:
calculate a magnitude value for the residuals;
determine an initial number of LSBs value;
determine that the number of LSBs is equal to the initial number of LSBs value when the magnitude value is less than a first threshold value;
determine that the number of LSBs is equal to the initial number of LSBs value plus one when the magnitude value is less than a second threshold value, wherein the second threshold value is larger than the first threshold value;
determine that the number of LSBs is equal to the initial number of LSBs value plus three when the magnitude value is greater than a third threshold value, wherein the third threshold value is larger than the second threshold value; and
determine that the number of LSBs is equal to the initial number of LSBs value plus two when the magnitude value is greater than the second threshold value and less than the third threshold value.

20. The device of claim 13, wherein the one or more processors are configured to encode the MSBs, store the encoded MSBs to the memory, and calculate the respective difference values between the respective raw sample values and the respective predicted values.

21. The device of claim 20, wherein each of the residuals comprises a residual value and a sign value representing whether the residual value is positive or negative, and wherein the one or more processing units are further configured to, for each of the residuals:
set an offset value according to an image characteristic when the number of LSBs is greater than one;
set the offset value equal to zero when the number of LSBs is less than or equal to one;
calculate a temporary MSBs value for a current residual of the residuals as being equal to the sign value for the current residual multiplied by a sum of an absolute value of the residual value for the current residual plus the offset value, the sum right-shifted by the number of LSBs;
calculate a max value as being equal to one left-shifted by a bit depth for the block, minus one; and
calculate an MSB value for the current residual as being equal to CLIP3(−(predictor value for the current residual right shifted by the number of LSBs), (max value minus the predictor value) right shifted by the number of LSBs, the temporary MSB value), wherein CLIP3(a, b, x)=Max(a, Min (b, x)).

22. The device of claim 21, wherein the one or more processors are further configured to, for each of the residuals, calculate an LSB value for the current residual as being equal to the residual value for the current residual minus the MSB value for the current residual left-shifted by the number of LSBs.

23. The device of claim 13, wherein the one or more processors are configured to:
retrieve encoded MSBs from the memory;
decode the encoded MSBs to reproduce the MSBs;
in response to determining not to represent the residuals using the LSBs:
determine a number of bits in the LSBs; and
left-shift the reproduced MSBs by the number of bits in the LSBs to reproduce a decoded version of the residuals of the samples of the block; and
add the respective predicted values to the respective reproduced residuals.

24. The device of claim 13, wherein the one or more processors are configured to determine the predicted value of a current sample using a value of at least one of a left-neighboring sample, an above-left neighboring sample, or an above-neighboring sample to the current sample.

25. A device for accessing image data, the device comprising:
means for coding most significant bits (MSBs) of a plurality of residuals of samples of a block of an image, each of the residuals representing a respective difference value between a respective raw sample value and a respective predicted value for the respective raw sample value;
means for accessing the coded MSBs in a first region of a memory;
means for determining whether to represent the residuals using both the MSBs and least significant bits (LSBs) of the plurality of residuals of the samples; and
means for preventing, in response to determining not to represent the residuals using the LSBs, access of the LSBs in a second region of the memory.

26. The device of claim 25, further comprising:
means for calculating a magnitude value for the residuals;
means for determining a number of bits in the LSBs based on whether the magnitude value is above or below a threshold value; and
means for calculating a number of bits in the MSBs as being equal to a bit depth of the residuals minus the number of bits in the LSBs.

27. The device of claim 25, wherein the means for coding the MSBs comprises means for encoding the MSBs, wherein the means for accessing the coded MSBs comprises means for storing the encoded MSBs, and wherein each of the residuals comprises a residual value and a sign value representing whether the residual value is positive or negative, further comprising:
means for calculating the respective difference values between the respective raw sample values and the respective predicted values;
means for setting an offset value according to an image characteristic when the number of LSBs is greater than one for each of the residuals;
means for setting the offset value equal to zero when the number of LSBs is less than or equal to one for each of the residuals;
means for calculating a temporary MSBs value for a current residual of the residuals as being equal to the sign value for the current residual multiplied by a sum of an absolute value of the residual value for the current residual plus the offset value, the sum right-shifted by the number of LSBs for each of the residuals;
means for calculating a max value as being equal to one left-shifted by a bit depth for the block, minus one for each of the residuals; and
means for calculating an MSB value for the current residual as being equal to CLIP3(−(predictor value for the current residual right shifted by the number of LSBs), (max value minus the predictor value) right shifted by the number of LSBs, the temporary MSB value), wherein CLIP3(a, b, x)=Max(a, Min (b, x)) for each of the residuals.

28. A computer-readable storage medium having stored thereon instructions that, when executed, cause a processor to:
code most significant bits (MSBs) of a plurality of residuals of samples of a block of an image, each of the residuals representing a respective difference value between a respective raw sample value and a respective predicted value for the respective raw sample value;
access the coded MSBs in a first region of a memory;
determine whether to represent the residuals using both the MSBs and least significant bits (LSBs) of the plurality of residuals of the samples; and
in response to determining not to represent the residuals using the LSBs, prevent access of the LSBs in a second region of the memory.

29. The computer-readable storage medium of claim 28, further comprising instructions that cause the processor to:
calculate a magnitude value for the residuals;
determine a number of bits in the LSBs based on whether the magnitude value is above or below a threshold value; and
calculate a number of bits in the MSBs as being equal to a bit depth of the residuals minus the number of bits in the LSBs.

30. The computer-readable storage medium of claim 28, wherein the instructions that cause the processor to code the MSBs comprise instructions that cause the processor to encode the MSBs, wherein the instructions that cause the processor to access the coded MSBs comprise instructions that cause the processor to store the encoded MSBs, and wherein each of the residuals comprises a residual value and a sign value representing whether the residual value is positive or negative, further comprising instructions that cause the processor to:
calculate the respective difference values between the respective raw sample values and the respective predicted values;
for each of the residuals:
set an offset value according to an image characteristic when the number of LSBs is greater than one;
set the offset value equal to zero when the number of LSBs is less than or equal to one;
calculate a temporary MSBs value for a current residual of the residuals as being equal to the sign value for the current residual multiplied by a sum of an absolute value of the residual value for the current residual plus the offset value, the sum right-shifted by the number of LSBs;
calculate a max value as being equal to one left-shifted by a bit depth for the block, minus one; and
calculate an MSB value for the current residual as being equal to CLIP3(−(predictor value for the current residual right shifted by the number of LSBs), (max value minus the predictor value) right shifted by the number of LSBs, the temporary MSB value), wherein CLIP3(a, b, x)=Max(a, Min (b, x)).
